(19) United States
(12) Patent Application Publication
(10) Pub. No.: US 2023/0292758 A1
(43) Pub. Date: Sep. 21, 2023

(54) COMPOSITIONS AND METHODS FOR CONTROLLLING FUNGAL DISEASES IN PLANTS

(71) Applicant: Bayer CropScience LP, St. Louis, MO (US)

(72) Inventors: Meagan IOTT, Citrus Heights, CA (US); Johan KIJLSTRA, Odenthal (DE); Heemanshu PATEL, Round Rock, TX (US); Kathy SANANIKONE, Sacramento, CA (US); Frisby Davis SMITH, Dixon, CA (US); Eunice TAN, Davis, CA (US)

(21) Appl. No.: 18/021,499

(22) PCT Filed: Aug. 18, 2021
(86) PCT No.: PCT/US2021/046442

§ 371 Date: Feb. 15, 2023

Related U.S. Application Data
(60) Provisional application No. 63/067,236, filed on Aug. 18, 2020.

(51) Int. Cl. A01N 43/72; A01N 43/90; A01N 41/04; A01N 63/22; A01P 3/00

(52) U.S. Cl. CPC A01N 43/72; A01N 43/90; A01N 41/04; A01N 63/22; A01P 3/00

(57) ABSTRACT

The present invention provides a fungicidal composition comprising: a) a microbial strain capable of producing a surfactin-type lipopeptide, an iturin-type lipopeptide, or a fengycin-type lipopeptide, or a combination thereof, or a fermentation product or cell-free preparation produced therefrom; and b) a compound of formula (I) or of formula (II) in a synergistically effective amount. Also provided is a method of controlling fungal harmful organisms in a plant with the fungicidal composition.

### CROSS REFERENCE TO RELATED APPLICATIONS

This application claims priority to U.S. Provisional Patent Application No. 63/067,236, filed Aug. 18, 2020, the contents of which are incorporated herein by reference in its entirety.

### TECHNICAL FIELD

The present invention relates to synergistic combinations of a lipopeptide-producing strain of Bacillus spp., such as Bacillus subtilis or Bacillus amyloliquefaciens, and a compound of formula (I) or of formula (II). The present invention also provides methods of controlling fungal diseases with synergistic compositions. The present invention also provides methods of preserving compositions comprising lipopeptide-producing soil microorganisms or lipopeptides, including antifungal and antibacterial lipopetides, with a compound of formula (I) or of formula (II).

### BACKGROUND

Fungicides have myriad uses, including for crop protection; as food, feed, and cosmetics preservatives; and as therapeutic agents for both human and veterinary applications. Crop yield reduction, foodborne diseases and fungal infections of both humans and animals are a problem in both developed and developing countries.

Non-ribosomal peptides, including cyclic amphiphilic lipopeptides such as surfactins, iturins and fengycins, are well-recognized for their antimicrobial properties and have been used in the field of crop protection. Because of their mode of action, they also have potential uses in biopharmaceutical and other biotechnology applications. Lipopeptides may be obtained through fermentation of various soil bacteria, including Bacillus subtilis and Bacillus amyloliquefaciens. Lipopeptides kill fungi by disrupting cell membranes. The potential for the development of fungal resistance to these compounds is expected to be very low since they act directly upon membrane lipids and not on a single site protein target. Further, lipopeptides are of low risk to workers and consumers; in fact, crops treated with Bacillus-based products may be harvested on the day of treatment.

Due to their hydrophobic nature, the surfactin-type, iturin-type and fengycin-type lipopeptides produced by various bacterial species (e.g., Bacillus subtilis and Bacillus amyloliquefaciens) may have limited bioavailability when applied to plants, plant parts, or soil. Compounds that enhance the bioavailability of these lipopeptides could increase their antifungal activity. An enhanced ability to disperse in an aqueous supernatant rather than to remain in a cell pellet may indicate increased lipopeptide bioavailability.

There is a need for improved formulations of lipopeptide-producing strains of surfactin-, iturin- and/or fengycin-type producing microogranisms, such as Bacillus spp., including Bacillus subtilis and Bacillus amyloliquefaciens, with increased antifungal activity. Improvements to the efficacy of Bacillus-based products, especially those that are not susceptible to development of fungal resistance, are highly desirable. There exists a continuing need in the art for such improvements to Bacillus-based fungicidal formulations.

Likewise, there exists a need for enhanced preservation of lipopeptide-containing formulations to improve shelf-life.

### SUMMARY

The present invention relates to enhanced formulations of a microorganism capable of producing a surfactin-type lipopeptide, an iturin-type lipopeptide, and/or a fengycin-type lipopeptide, or a fermentation product or cell-free preparation produced therefrom and a compound of formula (I) or of formula (II) in synergistically effective amount.

The present invention in one embodiment relates to enhanced formulations of a lipopeptide-producing strain of Bacillus spp. or a fermentation product or cell-free preparation produced therefrom and a compound of formula (I) or of formula (II) in synergistically effective amount. The present invention in another embodiment relates to enhanced formulations of a lipopeptide-producing strain of Bacillus subtilis or Bacillus amyloliquefaciens or a fermentation product or cell-free preparation produced therefrom and a compound of formula (I) or of formula (II) in synergistically effective amount. In a further embodiment, the lipopeptide-producing strain is capable of producing a surfactin-type lipopeptide, an iturin-type lipopeptide, and/or a fengycin-type lipopeptide.

In one embodiment, the present invention provides a fungicidal composition comprising: a) a lipopeptide-producing strain of Bacillus spp., such as Bacillus subtilis or Bacillus amyloliquefaciens or a fermentation product or cell-free preparation produced therefrom; and b) a compound of formula (I):

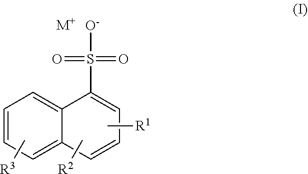

or a compound of formula (II):

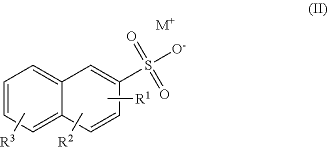

wherein R¹, R², and R³ are independently H or a linear or branched C₁₋₂₀ alkyl with the proviso that R¹, R², and R³ are not all H; and when it is present, M⁺ is selected from the group consisting of H⁺, Li⁺, Na⁺, and NH₄⁺; or an agriculturally acceptable salt, metal complex or metalloid complex of a compound of formula (I) or a compound of formula (II); in a synergistically effective amount.

In one aspect, R¹, R², and R³ are independently H, isopropyl, or butyl. In another aspect, component b) in the fungicidal composition is diisopropylnaphthalenesulfonic acid or an agriculturally acceptable salt, metal complex or metalloid complex thereof. In a specific embodiment, component b) is sodium diisopropylnaphthalenesulfonic acid.

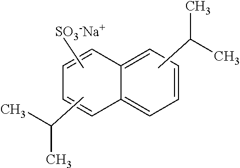

In another specific aspect, component b) is naphtahlene sulfonic acid butyl sodium salt and/or naphthalenesulfonic acid dibutyl sodium salt with sodium sulfate.

In yet another aspect, component b) is 2,3-di(propan-2-yl)naphthalene-1-sulfonic acid; 3,6-di(propan-2-yl)naphthalene sulfonic acid; 4,7-di(propan-2-yl)naphthalene-2-sulfonic acid; or an agriculturally acceptable salt, metal complex or metalloid complex thereof.

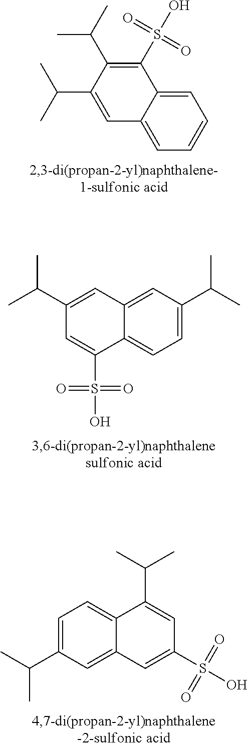

In a specific embodiment, component b) is sodium 2,3-di(propan-2-yl)naphthalene-1-sulfonic acid; sodium 3,6-di(propan-2-yl)naphthalene sulfonic acid; and sodium 4,7-di(propan-2-yl)naphthalene-2-sulfonic acid.

In yet another embodiment, the lipopeptide-producing strain of Bacillus spp. includes one or more of the following compounds: iturin A, plipastatins A and B, fengycins A and B, surfactin and agrastatin. In another embodiment, the lipopeptide-producing strain of Bacillus spp. includes two or more of the following compounds: iturin A, plipastatins A and B, fengycins A and B and surfactin. In yet another embodiment, the lipopeptide-producing strain of Bacillus spp. includes three or more of the following compounds: iturin A, plipastatins A and B, fengycins A and B, surfactin and agrastatin.

In another embodiment, the lipopeptide-producing strain of Bacillus subtilis or Bacillus amyloliquefaciens is Bacillus subtilis QST713, Bacillus amyloliquefaciens strain D747, Bacillus subtilis MBI600, Bacillus subtilis var. amyloliquefaciens FZB24, or a mutant thereof having all the identifying characteristics of the respective strain.

In certain aspects, the mutant of the lipopeptide-producing strain of Bacillus subtilis or Bacillus amyloliquefaciens has a genomic sequence with greater than about 90% sequence identity to the respective strain.

In another embodiment, the lipopeptide-producing strain of Bacillus subtilis or Bacillus amyloliquefaciens is part of a fermentation product. In certain aspects, the lipopeptide from the lipopeptide-producing strain of Bacillus subtilis or Bacillus amyloliquefaciens is an iturin-type compound, a surfactin-type compound, a fengycin-type compound, or a combination thereof.

In yet other aspects, the fungicidal composition additionally comprises at least one auxiliary selected from the group consisting of extenders, solvents, spontaneity promoters, carriers, emulsifiers, dispersants, frost protectants, thickeners and adjuvants.

In another embodiment, the present invention provides a method of controlling fungal harmful organisms in a plant, the method comprising applying an effective amount of the fungicidal composition of any one of the preceding claims to the plant, to a part of the plant and/or to a locus on which the plant or plant part grows or is to be planted.

In some aspects, the fungal harmful organisms are Phytophthora infestans and/or Botrytis cinerea and/or Plasmopara viticola and/or Sphaerotheca fuliginea and/or Venturia inaequalis and/or Alternaria solani and/or Uromyces appendiculatus and/or Phakopsora pachyrhizi.

In other aspects, the plant or crop is a fruit, grain, cereal or vegetable bearing plant such as but not limited to apples, bananas, citrus, kiwi, melons, peaches, pears, pineapple, pome fruit, pomegranate, cabbage, cauliflower, cucumbers, cucurbits, tomatoes, potatoes, wheat, rice and soybeans. In one embodiment, the fungicidal composition is applied as a foliar treatment.

In another aspect, the present invention provides a plant or plant part coated with the fungicidal composition. In one aspect, a crop harvested from the plant is coated with the fungicidal composition.

In a further aspect, the present invention provides a composition or formulation having enhanced stability and shelf-life, which composition or formulation comprises: a) a surfactin, iturin, and/or fengycin-producing strain or a fermentation product or cell-free preparation produced therefrom; and b) a compound of formula (I):

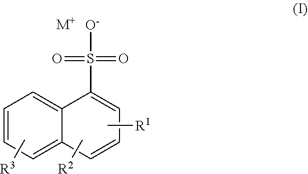

or a compound of formula (II):

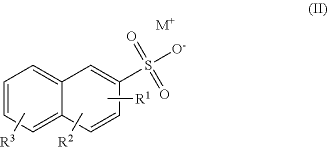

wherein R¹, R², and R³ are independently H or a linear or branched C₁₋₂₀ alkyl with the proviso that R¹, R², and R³ are not all H; and when it is present, M⁺ is selected from the group consisting of H⁺, Li⁺, Na⁺, K⁺, and NH₄⁺; or an agriculturally acceptable salt, metal complex or metalloid complex of a compound of formula (I) or a compound of formula (II); in a synergistically effective amount.

In one aspect of this embodiment, R¹, R², and R³ are independently H, isopropyl, or butyl. In another aspect, component b) in the fungicidal composition is diisopropylnaphthalenesulfonic acid or an agriculturally acceptable salt, metal complex or metalloid complex thereof. In yet another aspect, component b) is 2,3-di(propan-2-yl)naphthalene-1-sulfonic acid; 3,6-di(propan-2-yl)naphthalene sulfonic acid; 4,7-di(propan-2-yl)naphthalene-2-sulfonic acid; or an agriculturally acceptable salt, metal complex or metalloid complex thereof.

In another aspect, the stabilized pharmaceutical composition or pharmaceutical formulation comprises a surfactin, iturin and/or fengycin-producing microorganism or a fermentation product or cell-free preparation produced therefrom, wherein the lipopeptide is an antibacterial or an antifungal lipopeptide. In a specific embodiment, the microorganism is a Bacillus subtilis or a Bacillus amyloliquefaciens.

### BRIEF DESCRIPTION OF THE DRAWINGS

FIGS. 1A and 1B depict contact angle measurements and photographs of droplets formed by Bacillus subtilis QST713 Whole Broth (“WB”) mixed with one or more wetting agents.

FIG. 2 depicts relative levels of lipopeptides in extracted WB (“Extracted”), supernatant from WB (“Supernatant”), and WB or Bacillus subtilis QST713 Broth Concentrate (“BC”) containing 3% or 5% (w/w) of an adjuvant (“Adjuvant 1”) or sodium diisopropyl naphthalene sulfonate (“ANS”).

FIG. 3 depicts relative levels of lipopeptides in extracted supernatants from combinations of BC with increasing amounts of ANS.

FIG. 4 depicts average fungal disease control provided by WB mixed with 5% (w/w) ANS prior to final dilution in water (“5% In-Can”, black circles) or WB mixed with an equivalent amount of ANS after final dilution in water (“5% Equivalent in Tank-mix”, black squares).

FIG. 5 depicts relative levels of lipopeptides in extracted BC as well as in supernatants from combinations of BC with three different alkyl naphthalene sulfonate compounds.

FIG. 6 depicts residual antifungal activity on tomatoes treated with combinations of WB or BC with 3%, 5%, or 7.5% ANS that were applied at 10%, 5%, 2.5%, 1.25%, or 0.625% dilutions in water one day prior to inoculation of the tomatoes with Botrytis cinerea.

### DETAILED DESCRIPTION

It should be understood that any numerical range recited herein is intended to include all sub-ranges subsumed therein. For example, a range of 1 to 10 is intended to include all sub-ranges between and including the recited minimum value of 1 and the recited maximum value of 10, that is, having a minimum value equal to or greater than 1 and a maximum value of equal to or less than 10. Plural encompasses singular and vice versa; e.g., the singular forms “a”, “an”, and “the” include plural referents unless expressly and unequivocally limited to one referent.

As used herein, the term “fungal disease” is a disease caused by a fungus or a fungus-like microorganism (e.g., an oomycete).

“Crude extract,” as used herein, refers broadly to organic extracts of fermentation broth, including but not limited to ethyl acetate extracts, in which the extract is enriched for lipopeptides. Strains and methods for obtaining an extract of lipopeptides are also described herein.

“Fermentation broth,” as used herein, refers broadly to the culture medium resulting after fermentation of a microorganism (e.g., solid state or submerged fermentation process) and encompasses the microorganism and its component parts, unused raw substrates, and metabolites produced by the microorganism during fermentation, among other things.

“Fermentation product,” as used herein, refers to fermentation broth and/or fermentation solids.

“Fermentation solid,” as used herein, refers to harvested solids, concentrated and/or dried fermentation broth.

“Lipopeptides,” as used herein, refers to lipopeptides that are part of a fermentation product and to lipopeptides that are purified to at least some extent, whether chemically synthesized or biologically produced. Lipopeptides include but are not limited to amphiphilic cyclic lipopeptides.

It has been surprisingly discovered that the application of the composition according to the present invention in a simultaneous or sequential way to plants, plant parts, harvested fruits, vegetables and/or plant's locus of growth preferably allows better control of insects, mites, nematodes and/or phytopathogens than it is possible with the strains, their mutants and/or their metabolites produced by the strains on the one hand and with the individual compounds on the other hand, alone (synergistic mixtures). By applying the biological control agent and the specified compound according to the invention the activity against insects, mites, nematodes and/or phytopathogens is preferably increased in a superadditive manner. Preferably, the application of the composition according to the invention induces an increase in the activity of phytopathogens in a superadditive manner.

It has also been discovered that compositions and formulations of certain lipopeptides with the compounds of formula (I) or formula (II) exhibit enhanced stability to undersirable microbial contamination over time, up to 130 weeks. As such, the invention also provides stable compositions and formulations, including pharmaceutical compositions, comprising lipopeptides in combination with compounds of formula (I) or formula (II).

In some embodiments, the compounds of the present invention may be combined with or used in combination with a lipopeptide. For example, the method of treating a plant to control a fungal disease may further comprise simultaneously or sequentially applying to the plant, to the part of the plant and/or to the locus of the plant a lipopeptide.

The lipopeptide may be part of or an extract of a fungicidal lipopeptide-containing fermentation product. In certain aspects, lipopeptide-containing fermentation product is a Bacillus sp. such as, for example, Bacillus subtilis QST713 or its variants; Bacillus amyloliquefaciens strain D747; Bacillus subtilis MBI600; Bacillus subtilis Y1336; Bacillus amyloliquefaciens strain FZB42; or Bacillus subtilis var. amyloliquefaciens FZB24.

The weight to weight ratio of the compound and the lipopeptide (or, alternatively, the lipopeptide component (e.g., a lipopeptide-containing fermentation broth, a cell-free preparation, a crude extract containing lipopeptides; a purified or semi-purified lipopeptide extract; or chemically synthesized or derivatized pure lipopeptide(s)) is in the range of about 10,000:1 to about 1:10,000, preferably in the range of about 1,000:1 to about 1:1,000, preferably in the range of about 500:1 to about 1:500, more preferably in the range of about 100:1 to about 1:100.

In certain aspects, the a) lipopeptide-producing strain of Bacillus subtilis or Bacillus amyloliquefaciens or a fermentation product or cell-free preparation produced therefrom; and b) a compound of formula (I) or of formula (II) are combined in an a) to b) weight ratio in the range of about 10,000:1 to about 1:10,000, preferably in the range of about 1,000:1 to about 1:1,000, preferably in the range of about 500:1 to about 1:500, more preferably in the range of about 100:1 to about 1:100. In other aspects, component b) is added to component a) to a concentration of at least 0.25%, 0.5% or 1% (w/w). In yet other aspects, the concentration of component b) in the fungicidal composition is in the range of about 0.01% to about 40% (w/w), in the range of about 0.01% to about 10% (w/w), in the range of about 0.1% to about 7.5% (w/w), or in the range of about 0.25% to about 5.5% (w/w).

A ratio of about 100:1 means about 100 parts of compound (e.g., ANS) and about 1 part of the lipopeptide or lipopeptide component such as the Bacillus subtilis QST713 fermentation product are combined (either as a solo formulation, a combined formulation or by separate applications to plants so that the combination is formed on the plant).

In one embodiment, the weight ratio of compound of the present invention to pure lipopeptides comprised of one or more compounds from one or more of the following families of compounds, surfactin-type compounds, iturin-type compounds, fengycin-type compounds, and/or fusaricidins is in the range of about 10,000:1 to about 1:10,000, in the range of about 1,000:1 to about 1:1,000, preferably in the range of about 500:1 to about 1:500, more preferably in the range of about 100:1 to about 1:100, in the range of about 50:1 to about 1:50, or in the range of about 25:1 to about 1:25. In some embodiments, the weight to weight ratio of any of the above-described combinations of the compound and the lipopeptide or lipopeptide component is about 10,000:1 to about 1:10,000, about 1,000:1 to about 1:1,000, about 500:1 to about 1:500, or about 100:1 to about 1:100; in others it is about 10:1 to about 1:10; in still others it is about 5:1 to about 1:5; in yet others it is about 3:1 to about 1:3; and in yet others it is about 1:1.

In another embodiment, the weight ratio of compound(s) of the present invention to lipopeptide-containing fermentation broth (e.g., Bacillus subtilis QST713 fermentation broth) is in the range of about 500:1 to about 1:500, more preferably in the range of about 100:1 to about 1:100, in the range of about 50:1 to about 1:50, or in the range of about 25:1 to about 1:25. In some embodiments, the weight to weight ratio of a) the compound and b) the lipopeptide (or, alternatively, the lipopeptide component (e.g., a lipopeptide-containing fermentation broth, a crude extract containing lipopeptides; a purified or semi-purified lipopeptide extract; or chemically synthesized or derivatized pure lipopeptide(s)) is about 1:5 to about 1:120. In certain aspects, this weight to weight ratio is about 1:5, about 1:10, about 1:15, about 1:19, about 1:20, about 1:24, about 1:25, about 1:30, about 1:50, about 1:60, about 1:75, or about 1:120.

The compound (e.g., ANS) and the lipopeptide or lipopeptide component are used or employed in a synergistic ratio. The skilled person understands that these ratios refer to the ratio within a combined-formulation as well as to the calculative ratio of the compound (e.g., ANS) described herein and the lipopeptide or lipopeptide component when both components are applied as in-can, copack or tank-mix formulations to a plant to be treated. The skilled person can calculate this ratio by simple mathematics since the volume and the amount of the compound (e.g., ANS) and the lipopeptide or lipopeptide component, respectively, in a mono-formulation is known to the skilled person.

The ratio can be calculated based on the amount of the compound (e.g., ANS), at the time point of applying said component of a combination according to the invention to a plant or plant part and the amount of and the lipopeptide or lipopeptide component shortly prior (e.g., 48 h, 24 h, 12 h, 6 h, 2 h, 1 h) or at the time point of applying said component of a combination according to the invention to a plant or plant part. The application of the compound (e.g., ANS) and the lipopeptide or lipopeptide component to a plant or a plant part can take place simultaneously or at different times as long as both components are present on or in the plant after the application(s).

Typically, the lipopeptide-containing fermentation product when applied to a seed is applied at a rate of about 1×10² to about 1×10⁷ cfu/seed, depending on the size of the seed. In some embodiments, the application rate is about 1×10³ to about 1×10⁶ cfu per seed.

When used as a soil treatment, lipopeptide-containing fermentation product can be applied as a soil surface drench, shanked-in, injected and/or applied in-furrow or by combination with irrigation water. The rate of application for drench soil treatments, which may be applied at planting, during or after seeding, or after transplanting and at any stage of plant growth, is typically about 4×1⁰¹¹ to about 8×10¹² cfu per acre. In some embodiments, the rate of application is about 1×10¹² to about 6×10¹² cfu per acre. In some embodiments, the rate of application is about 6×10¹² to about 8×10¹² cfu per acre. The rate of application for in-furrow treatments, applied at planting, is about 2.5×10¹⁰ to about 5×10¹¹ cfu per 1000 row feet. In some embodiments, the rate of application is about 6×10¹⁰ to about 4×10¹¹ cfu per 1000 row feet. In other embodiments, the rate of application is about 3.5×10¹¹ cfu per 1000 row feet to about 5×10¹¹ cfu per 1000 row feet.

In some embodiments, the lipopeptide is part of or an extract of a fungicidal lipopeptide-containing fermentation product. The lipopeptide-containing fermentation product may be from a Bacillus spp. In one aspect, the Bacillus spp. is Bacillus subtilis or Bacillus amyloliquefaciens. In another aspect, the Bacillus spp. is Bacillus subtilis QST713 or a fungicidal mutant strain derived therefrom. In one embodiment, the fungicidal mutant strain has a genomic sequence with greater than about 90% sequence identity to Bacillus subtilis QST713.

In other aspects, the Bacillus sp. is Bacillus amyloliquefaciens strain D747; Bacillus subtilis MBI600; Bacillus subtilis Y1336; Bacillus amyloliquefaciens strain FZB42; or Bacillus subtilis var. amyloliquefaciens FZB24.

In some embodiments, the lipopeptide is an iturin-type compound, a surfactin-type compound, a fengycin-type compound, a fusaricidin, or a combination thereof. In one aspect, the lipopeptide is an iturin-type compound. The iturin-type compound may be bacillomycin D, bacillomycin F, bacillomycin L, bacillomycin LC (bacillopeptin), mycosubtilin, iturin A, iturin AL, or iturin C.

In another aspect, the lipopeptide is a fengycin-type compound. The fengycin-type compound may be fengycin A, fengycin B, plipastatin A, plipastatin B, or an agrastatin.

In yet another aspect, the lipopeptide is a surfactin-type compound. The surfactin-type compound may be esperin, lichenysin, pumilacidin, or surfactin.

In some embodiments, the present invention is directed to a method of controlling fungal harmful organisms and/or bacterial harmful organisms in a plant, the method comprising applying an effective amount of a synergistic composition described herein to the plant, to a part of the plant and/or to a locus on which the plant or plant part grows.

In some aspects, the fungal harmful organisms are Phytophthora infestans and/or Botrytis cinerea and/or Plasmopara viticola and/or Sphaerotheca fuliginea and/or Venturia inaequalis and/or Alternaria solani and/or Uromyces appendiculatus and/or Phakopsora pachyrhizi.

In one embodiment, the lipopeptide is part of or is an extract of a fermentation product from Bacillus species bacteria, such as those described herein. In another instance of this embodiment, prior to making the combination, a lipopeptide-producing bacteria is selected, such as a Bacillus species strain or Paenibacillus species strain, and a fermentation product containing lipopeptides is produced using this lipopeptide-producing bacteria, and such fermentation product or an extract thereof is used to make the combination. In one embodiment, such fermentation product would include one or more of the following lipopeptides: surfactin-type compounds, fengycin-type compounds, iturin-type compounds and/or fusaricidin. In a more particular embodiment, such fermentation product would include one or more of the following lipopeptides: surfactin, plipastatin, fengycin, iturin and/or bacillomycin.

In certain aspects, the methods disclosed herein are used to control a fungal disease wherein the fungal disease is Grey Mould caused by Botrytis cinerea, Late Blight caused by Phytophthora infestans, Downy Mildew caused by Plasmopara viticola, Powdery Mildew caused by Sphaerotheca fuliginea, Apple Scab caused by Venturia inaequalis, Bean Rust caused by Uromyces appendiculatus, or Soybean Rust caused by Phakopsora pachyrhizi.

In certain aspects, the lipopeptide is part of or is an extract of a fermentation product from Bacillus species bacteria, such as those described herein. In another instance of this embodiment, prior to making the combination, a lipopeptide-producing bacteria is selected, such as a Bacillus species strain or Paenibacillus species strain, and a fermentation product containing lipopeptides is produced using this lipopeptide-producing bacteria, and such fermentation product or an extract thereof is used to make the combination. In one embodiment, such fermentation product would include one or more of the following lipopeptides: surfactin-type compounds, fengycin-type compounds, iturin-type compounds and/or fusaricidin. In a more particular embodiment, such fermentation product would include one or more of the following lipopeptides: surfactin, plipastatin, fengycin, iturin and/or bacillomycin.

Non-limiting examples of pathogens of fungal diseases which can be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator;

diseases caused by rust disease pathogens, for example Gymnosporangium species, for example Gymnosporangium sabinae; Hemileia species, for example Hemileia vastatrix; Phakopsora species, for example Phakopsora pachyrhizi and Phakopsora meibomiae; Puccinia species, for example Puccinia recondite, P. triticina, P. graminis or P. striiformis or P. hordei; Uromyces species, for example Uromyces appendiculatus;

diseases caused by pathogens from the group of the Oomycetes, for example Albugo species, for example Albugo candida; Bremia species, for example Bremia lactucae; Peronospora species, for example Peronospora pisi, P. parasitica or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;

leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidia form: Drechslera, Syn: Helminthosporium), Cochliobolus miyabeanus; Colletotrichum species, for example Colletotrichum lindemuthanium; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans, Leptosphaeria nodorum; Magnaporthe species, for example Magnaporthe grisea; Microdochium species, for example Microdochium nivale; Mycosphaerella species, for example Mycosphaerella graminicola, M. arachidicola and M. fijiensis; Phaeosphaeria species, for example Phaeosphaeria nodorum; Pyrenophora species, for example Pyrenophora teres, Pyrenophora tritici repentis; Ramularia species, for example Ramularia collo-cygni, Ramularia areola; Rhynchosporium species, for example Rhynchosporium secalis; Septoria species, for example Septoria apii, Septoria lycopersii; Typhula species, for example Typhula incarnata; Venturia species, for example Venturia inaequalis;

root and stem diseases caused, for example, by Corticium species, for example Corticium graminearum; Fusarium species, for example Fusarium oxysporum; Gaeumannomyces species, for example Gaeumannomyces graminis; Rhizoctonia species, such as, for example Rhizoctonia solani; Sarocladium diseases caused for example by Sarocladium oryzae; Sclerotium diseases caused for example by Sclerotium oryzae; Tapesia species, for example Tapesia acuformis; Thielaviopsis species, for example Thielaviopsis basicola;

ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Septoria species, for example Septoria nodorum;

diseases caused by smut fungi, for example Sphacelotheca species, for example Sphacelotheca reiliana; Tilletia species, for example Tilletia caries, T. controversa; Urocystis species, for example Urocystis occulta; Ustilago species, for example Ustilago nuda, U. nuda tritici;

fruit rot caused, for example, by Aspergillus species, for example Aspergillus flavus; Botrytis species, for example Botrytis cinerea; Penicillium species, for example Penicillium expansum and P. purpurogenum; Sclerotinia species, for example Sclerotinia sclerotiorum; Verticilium species, for example Verticilium alboatrum;

seed and soilborne decay, mould, wilt, rot and damping-off diseases caused, for example, by Alternaria species, caused for example by Alternaria brassicicola; Aphanomyces species, caused for example by Aphanomyces euteiches; Ascochyta species, caused for example by Ascochyta lentis; Aspergillus species, caused for example by Aspergillus flavus; Cladosporium species, caused for example by Cladosporium herbarum; Cochliobolus species, caused for example by Cochliobolus sativus; (Conidiaform: Drechslera, Bipolaris Syn: Helminthosporium); Colletotrichum species, caused for example by Colletotrichum coccodes; Fusarium species, caused for example by Fusarium culmorum; Gibberella species, caused for example by Gibberella zeae; Macrophomina species, caused for example by Macrophomina phaseolina; Monographella species, caused for example by Monographella nivalis; Penicillium species, caused for example by Penicillium expansum; Phoma species, caused for example by Phoma lingam; Phomopsis species, caused for example by Phomopsis sojae; Phytophthora species, caused for example by Phytophthora cactorum; Pyrenophora species, caused for example by Pyrenophora graminea; Pyricularia species, caused for example by Pyricularia oryzae; Pythium species, caused for example by Pythium ultimum; Rhizoctonia species, caused for example by Rhizoctonia solani; Rhizopus species, caused for example by Rhizopus oryzae; Sclerotium species, caused for example by Sclerotium rolfsii; Septoria species, caused for example by Septoria nodorum; Typhula species, caused for example by Typhula incarnata; Verticillium species, caused for example by Verticillium dahliae;

cancers, galls and witches' broom caused, for example, by Nectria species, for example Nectria galligena;

wilt diseases caused, for example, by Monilinia species, for example Monilinia laxa;

leaf blister or leaf curl diseases caused, for example, by Exobasidium species, for example Exobasidium vexans;

Taphrina species, for example Taphrina deformans;

decline diseases of wooden plants caused, for example, by Esca disease, caused for example by Phaemoniella clamydospora, Phaeoacremonium aleophilum and Fomitiporia mediterranea; Eutypa dyeback, caused for example by Eutypa lata; Ganoderma diseases caused for example by Ganoderma boninense; Rigidoporus diseases caused for example by Rigidoporus lignosus;

diseases of flowers and seeds caused, for example, by Botrytis species, for example Botrytis cinerea;

diseases of plant tubers caused, for example, by Rhizoctonia species, for example Rhizoctonia solani; Helminthosporium species, for example Helminthosporium solani;

Club root caused, for example, by Plasmodiophora species, for example Plamodiophora brassicae;

diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora.

Fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The inventive compositions can be used for curative or protective/preventive control of phytopathogenic fungi. The invention therefore also relates to curative and protective methods for controlling phytopathogenic fungi by the use of the inventive composition, which is applied to the seed, the plant or plant parts, the fruit or the soil in which the plants grow.

Compositions of the present invention are useful in various fungal control applications. The above-described compositions may be used to control fungal phytopathogens, post-harvest fungal pathogens, fungal pathogens of food or feed and human fungal pathogens.

In one embodiment, any of the above-described compositions are used to control target pathogens such as Fusarium species, Botrytis species, Verticillium species, Rhizoctonia species, Trichoderma species and Pythium species by applying the composition to plants, the area surrounding plants, or edible cultivated mushrooms, mushroom spawn or mushroom compost.

In another embodiment, compositions of the present invention are used to control post-harvest pathogens such as Penicillium, Geotrichum, Aspergillus niger, and Colletotrichum species.

In yet another embodiment, compositions of the present invention are used to control fungal pathogens that occur in food or feed, such as Penicillium species, Aspergillus species and Fusarium species.

In one embodiment, the synergistic fungicidal combination comprises a lipopeptide and an agriculturally acceptable detergent. The detergent may be any detergent known in the art for use in agricultural formulations having the purpose, for example, of causing the formulation to stick to the surface of the target plant. It is to be appreciated that preferred detergents are completely biodegradable and environmentally friendly.

In certain aspects, the lipopeptide component of the above-referenced compositions includes one or more of the following: iturin, bacillomycin, mycosubtilin, esperin, lichenysin, pumilacidin, surfactin, fengycin A, fengycin B, plipastatin A, plipastatin B, and/or agrastatin. In one instance of the aforementioned embodiment, the lipopeptide component includes one or more of the following: iturin, surfactin, fengycin and/or plipastatin.

Lipopeptides include but are not limited to amphiphilic cyclic peptides obtainable from various bacteria, including Bacillus sp., Paenibacillus sp., and Streptomyces sp.

Amphiphilic cyclic lipopeptides are composed of six to ten α-amino acids linked to a β-amino or β-hydroxy fatty acid, including but not limited to fengycin-type compounds, iturin-type compounds, surfactin-type compounds and fusaricidins. The iturin-type compounds are composed of seven amino acids and are linked to a β-amino fatty acid. The length of the fatty acid chain may vary from C14 to C17. These compounds are obtainable from various species of Bacillus, including subtilis and amyloliquefaciens. The iturins and their variants are described in Ongena, et al., “Bacillus Lipopeptides: Versatile Weapons for Plant Disease Biocontrol,” Trends in Microbiology, 16(3):115-125, (2007). Iturin-type compounds of the present invention include one or more of the following compounds: bacillomycin D, bacillyomycin F, bacillomycin L, bacillomycin LC (also known as bacillopeptin), mycosubtilin, iturin A, iturin A_{L}, and iturin C (with the latter three compounds referred to herein, collectively, as iturins).

Fengycin-type compounds are composed of ten amino acids linked to a β-hydroxy fatty acid with a chain that varies in length from C14 to C18. These compounds are obtainable from various species of Bacillus, including subtilis, amyloliquefaciens, cereus and thuringiensis and from Streptomyces sp. The fengycin-type compounds are described in Ongena, supra. Fengycin-type compounds suitable for the compositions described herein include fengycin A, fengycin B, plipastatin A, plipastatin B, the plipastatins from a Streptomyces sp. described in Kimura, et al., “SNA 60-367—New Peptide Enzyme Inhibitors against Aromatase,” Journal of Antibiotics, 50(6): 529-531, (1997), and agrastatins, as described in U.S. Pat. No. 6,291,426 (with the latter four listings referred to herein, collectively, as plipastatins).

Surfactin-type compounds are composed of seven amino acids linked to a β-hydroxy fatty acid with a chain that varies in length from C13 to C16. These compounds are obtainable from various species of Bacillus, including subtilis, amyloliquefaciens, coagulans, pumilus and licheniformis. The surfactin family of compounds is described in Ongena, supra. Surfactin-type compounds of the present invention include one or more of the following compounds: esperin, lichenysin, pumilacidin and surfactin.

Fusaricidins are composed of six amino acids linked to a 15-guanidino-3-hydroxypentadecanoic acid. Fusaricidins are obtainable from Paenibacillus sp., including polymyxa. The fusaricidin family of compounds is described in Choi, S-K, et al., “Identification and Functional Analysis of the Fusaricidin Biosynthetic Gene of Paenibacillus polymyxa E681,” Biochemical and Biophysical Research Communications, 365:89-95, (2008). Fusaricidins of the present invention include one or more of the following compounds: fusaricidins A-D and fusaricidins LI-F03, LI-F04, LI-F05, LI-F06, LI-F07 and LI-F08.

Certain bacteria produce one or more lipopeptides, and combinations of various lipopeptides are known to have synergistic fungicidal activity. The lipopeptide component of the composition may comprise a combination of lipopeptides from at least two of the following lipopeptide classes: surfactin-type compounds, iturin-type compounds, and fengycin-type compounds. The combination may comprise two or more of the following compounds: iturin A, plipastatins A and B, fengycins A and B and surfactin. The combination may comprise one or more of the following compounds: iturin A, plipastatins A and B, fengycins A and B, surfactin and agrastatin.

In certain aspects, the compound of the present invention may be combined with or applied together with a depsipeptide. As used herein, a “depsipeptide” is a peptide in which one or more of the amide bonds are replaced by ester bonds. In certain embodiments, the depsipeptide is a cyclic depsipeptide. Non-limiting examples of depsipeptides that may be used with the present invention include fusaricidins A-D and fusaricidins LI-F03, LI-F04, LI-F05, LI-F06, LI-F07 and LI-F08.

Lipopeptides and depsipeptides of the present invention are produced by one or more bacteria, including but not limited to those described above, or are chemically synthesized. Methods of culturing bacteria are well known in the art. Conventional large-scale microbial culture processes include submerged fermentation, solid state fermentation, or liquid surface culture. For Bacillus, towards the end of fermentation, as nutrients are depleted, cells begin the transition from growth phase to sporulation phase, such that the final product of fermentation is largely spores, metabolites and residual fermentation medium. Sporulation is part of the natural life cycle of many Bacilli and is generally initiated by the cell in response to nutrient limitation. For this invention, fermentation is configured to obtain high levels of lipopeptides and to promote sporulation.

The bacterial cells, spores and metabolites in culture media resulting from fermentation (i.e., fermentation broth) may be used directly or concentrated (to make a fermentation solid) by conventional industrial methods, including but not limited to centrifugation, tangential-flow filtration, depth filtration, and evaporation. The concentrated fermentation solid is washed, for example, via a diafiltration process, to remove residual fermentation broth and metabolites.

The fermentation broth or fermentation solids can be harvested or dried with or without the addition of carriers using conventional drying processes or methods including but not limited to spray drying, freeze drying, tray drying, fluidized-bed drying, drum drying, or evaporation. The resulting dry fermentation solids may be further processed, including but not limited to by milling or granulation, to achieve a specific particle size or physical format. Carriers may also be added post-drying, as appropriate for the desired method of use.

Bacterially produced lipopeptides may be separated from bacterial cells or further purified from other bacterial components and, from each other. The term “cell-free preparation” refers to fermentation broth from which cells have been removed or substantially removed through means well known to those of skill in the art. Cell-free preparations of fermentation broth can be obtained by any means known in the art, including but not limited to extraction, centrifugation and/or filtration of fermentation broth. Those of skill in the art will appreciate that so-called cell-free preparations may not be devoid of cells but rather are largely cell-free or substantially cell-free, depending on the technique used (e.g., speed of centrifugation) to remove the cells. The resulting cell-free preparation may be dried and/or formulated with components that aid in its particular application. Concentration methods and drying techniques described above for fermentation broth are also applicable to cell-free preparations.

After a cell-free preparation is made by centrifugation of fermentation broth, the metabolites may be purified by size exclusion filtration including but not limited to the SEPHADEX® resins including LH-20, G10, and G15 and G25 that group metabolites into different fractions based on molecular weight cut-off, including but not limited to molecular weight of less than about 2,000 daltons, less than about 1,500 daltons, less than about 1,000 daltons and so on, as the lipopeptides are between 800 daltons and 1,600 daltons.

Lipopeptides of the present invention may be obtained from or are present in lipopeptide-containing fermentation products of Bacillus subtilis. In some embodiments, Bacillus subtilis QST713 or a fermentation product of Bacillus subtilis QST713 is used as the lipopeptide-containing component of the composition. Bacillus subtilis QST713, its mutants, its supernatants, and its lipopeptide metabolites, and methods for their use to control plant pathogens and insects are fully described in U.S. Pat. Nos. 6,060,051; 6,103,228; 6,291,426; 6,417,163 and 6,638,910. In these patents, the strain is referred to as AQ713, which is synonymous with QST713. Bacillus subtilis strain QST713 has been deposited with the NRRL on 7 May 1997, under the provisions of the Budapest Treaty on the International Recognition of the Deposit of Microorganisms for the Purpose of Patent Procedure under Accession Number B-21661. NRRL is the abbreviation for the Agricultural Research Service Culture Collection, an international depositary authority for the purposes of deposing microorganism strains under the Budapest Treaty on the International Recognition of the Deposit of Microorganisms for the Purposes of Patent Procedure, having the address National Center for Agricultural Utilization Research, Agricultural Research Service, U.S. Department of Agriculture, 1815 North University Street, Peoria, Illinois 61604, U.S.A. Any references in this specification to QST713 refer to Bacillus subtilis QST713. Particular variants of Bacillus subtilis QST713 (e.g., Bacillus subtilis AQ30002 and AQ30004, deposited as Accession Numbers NRRL B-50421 and NRRL B-50455) that would also be suitable for the present invention are described in U.S. Patent Publication No. 2012/0231951.

Any references in this specification to QST713 refer to Bacillus subtilis QST713 (aka AQ713) as present in the SERENADE® products, deposited under NRRL Accession No. B-21661, or prepared in bioreactors under conditions that simulate production of the SERENADE® product.

The microorganisms and particular strains described herein, unless specifically noted otherwise, are all separated from nature (i.e., isolated) and grown under artificial conditions such as in shake flask cultures or through scaled-up manufacturing processes, such as in bioreactors to maximize bioactive metabolite production, for example.

In certain aspects of the invention, a mutant strain of Bacillus subtilis QST713 is provided. The term “mutant” refers to a genetic variant derived from Bacillus subtilis QST713. In one embodiment, the mutant has one or more or all the identifying (functional) characteristics of Bacillus subtilis QST713. In a particular instance, the mutant or a fermentation product thereof controls (as an identifying functional characteristic) fungi, Oomycetes and/or bacteria at least as well as the parent Bacillus subtilis QST713. Such mutants may be genetic variants having a genomic sequence that has greater than about 85%, greater than about 90%, greater than about 95%, greater than about 98%, or greater than about 99% sequence identity to Bacillus subtilis QST713. Mutants may be obtained by treating Bacillus subtilis QST713 cells with chemicals or irradiation or by selecting spontaneous mutants from a population of Bacillus subtilis QST713 cells (such as phage resistant or antibiotic resistant mutants) or by other means well known to those practiced in the art.

The mutant strain can be any mutant strain that has one or more or all the identifying characteristics of Bacillus subtilis QST713 and in particular fungicidal activity that is comparable or better than that of Bacillus subtilis QST713.

At the time of filing U.S. patent application Ser. No. 09/074,870, in 1998, which corresponds to the above patents, the strain was designated as Bacillus subtilis based on classical, physiological, biochemical and morphological methods. Taxonomy of the Bacillus species has evolved since then, especially in light of advances in genetics and sequencing technologies, such that species designation is based largely on DNA sequence rather than the methods used in 1998. After aligning protein sequences from B. amyloliquefaciens FZB42, B. subtilis 168 and QST713, approximately 95% of proteins found in B. amyloliquefaciens FZB42 are 85% or greater identical to proteins found in QST713; whereas only 35% of proteins in B. subtilis 168 are 85% or greater identical to proteins in QST713. However, even with the greater reliance on genetics, there is still taxonomic ambiguity in the relevant scientific literature and regulatory documents, reflecting the evolving understanding of Bacillus taxonomy over the past 15 years. For example, a pesticidal product based on B. subtilis strain FZB24, which is as closely related to QST713 as FZB42, is classified in documents of the U.S. EPA as B. subtilis var. amyloliquefaciens. Due to these complexities in nomenclature, this particular Bacillus species is variously designated, depending on the document, as B. subtilis, B. amyloliquefaciens, and B. subtilis var. amyloliquefaciens. Therefore, we have retained the B. subtilis designation of QST713 rather than changing it to B. amyloliquefaciens, as would be expected currently based solely on sequence comparison and inferred taxonomy.

Suitable formulations of the Bacillus subtilis strain QST713 are commercially available under the trade names SERENADE®, SERENADE® ASO, SERENADE SOIL® and SERENADE® MAX from Bayer CropScience LP, Missouri, U.S.A.

The SERENADE® product (U.S. EPA Registration No. 69592-12) contains a patented strain of Bacillus subtilis (strain QST713) and many different lipopeptides that work synergistically to destroy disease pathogens and provide superior antimicrobial activity. The SERENADE® product is used to protect plants such as vegetables, fruit, nut and vine crops against diseases such as Fire Blight, Botrytis, Sour Rot, Rust, Sclerotinia, Powdery Mildew, Bacterial Spot and White Mold. The SERENADE® products are available as either liquid or dry formulations which can be applied as a foliar and/or soil treatment. Copies of U.S. EPA Master Labels for the SERENADE® products, including SERENADE® ASO, SERENADE® MAX, and SERENADE SOIL®, are publicly available through National Pesticide Information Retrieval System's (NPIRS®) US EPA/OPP Pesticide Product Label System (PPLS).

SERENADE® ASO (Aqueous Suspension-Organic) contains 1.34% of dried QST713 as an active ingredient and 98.66% of other ingredients. SERENADE® ASO is formulated to contain a minimum of 1×10⁹ cfu/g of QST713 while the maximum amount of QST713 has been determined to be 3.3×10¹⁰ cfu/g. Alternate commercial names for SERENADE® ASO include SERENADE® BIOFUNGICIDE, SERENADE SOIL® and SERENADE® GARDEN DISEASE. For further information, see the U.S. EPA Master Labels for SERENADE® ASO dated Jan. 4, 2010, and SERENADE SOIL®, each of which is incorporated by reference herein in its entirety.

SERENADE® MAX contains 14.6% of dried QST713 as an active ingredient and 85.4% of other ingredients. SERENADE® MAX is formulated to contain a minimum of 7.3×10⁹ cfu/g of QST713 while the maximum amount of QST713 has been determined to be 7.9×10¹⁰ cfu/g. For further information, see the U.S. EPA Master Label for SERENADE® MAX, which is incorporated by reference herein in its entirety.

Other Bacillus strains capable of producing lipopeptides may be used as a source of lipopeptides for the present invention. For example, Bacillus amyloliquefaciens strain D747 (available as BACSTAR® from Etec Crop Solutions, NZ and also available as DOUBLE NICKEL55™ from Certis, US); Bacillus subtilis MBI600 (available as SUBTILEX® from Becker Underwood, US EPA Reg. No. 71840-8); Bacillus subtilis Y1336 (available as BIOBAC® WP from Bion-Tech, Taiwan, registered as a biological fungicide in Taiwan under Registration Nos. 4764, 5454, 5096 and 5277); Bacillus amyloliquefaciens, in particular strain FZB42 (available as RHIZOVITAL® from ABiTEP, DE); Bacillus subtilis var. amyloliquefaciens FZB24 is available from Novozymes Biologicals Inc. (Salem, Virginia) or Syngenta Crop Protection, LLC (Greensboro, North Carolina) as the fungicide TAEGRO® or TAEGRO® ECO (EPA Registration No. 70127-5), and Bacillus subtilis EA-CB0015 and Bacillus amyloliquefaciens EA-CB0959 (described in International Patent Publication No. WO/2014/178032) are all Bacillus strains capable of producing lipopeptides that may be used as a source of lipopeptides for the present invention.

A mutant of FZB24 that was assigned Accession No. NRRL B-50349 by the Agricultural Research Service Culture Collection is also described in U.S. Patent Publication No. 2011/0230345. Bacillus amyloliquefaciens FZB42 is available from ABiTEP GMBH, Germany, as the plant strengthening product RHIZOVITAL®; FZB42 is also described in European Patent Publication No. EP2179652 and also in Chen, et al., “Comparative Analysis of the Complete Genome Sequence of the Plant Growth-Promoting Bacterium Bacillus amyloliquefaciens FZB42,” Nature Biotechnology, Volume 25, Number 9 (September 2007). Mutants of FZB42 are described in International Patent Publication No. WO 2012/130221, including Bacillus amyloliquefaciens ABI01, which was assigned Accession No. DSM 10-1092 by the DSMZ—German Collection of Microorganisms and Cell Cultures.

As described above, fermentation broth or extracts from fermentation broth may be used as the lipopeptide-containing component of the synergistic fungicidal combination of the present invention. Obtaining lipopeptides from fermentation broth of Bacillus bacteria, in general, and analyzing fermentation broths for presence of lipopeptides is well known to those of skill in the art, such that other bacterial strains suitable for the present invention could be readily identified by the skilled artisan. Bacillus strains that produce various lipopeptides are described in Ongena, Trends in Microbiology (2007) Vol. 16, No. 3. Other articles describe lipopeptide-producing Bacillus strains and methods for extracting lipopeptides from fermentation broths of such strains: see, e.g., Alvarez, et al., Journal of Applied Microbiology (2011) 112: 159-174; Ongena, et al., Applied Microbiology.

Compositions of the present invention may include carriers, which are inert formulation ingredients added to compositions comprising a lipopeptide-containing fermentation product, cell-free preparations of lipopeptides or purified, semi-purified or crude extracts of lipopeptides to improve recovery, efficacy, or physical properties and/or to aid in packaging and administration. Such carriers may be added individually or in combination.

The compositions of the present invention may be used for various purposes, including protection of crops and of post-harvest fruits, vegetables and plants; as preservatives for cosmetics, processed foods, animal feed, or timber; and for pharmaceutical and veterinary applications. Depending on the particular application, the compositions will be formulated with appropriate carriers to aid in their application or administration. The carriers may be anti-caking agents, anti-oxidation agents, bulking agents, and/or protectants. Examples of useful carriers include polysaccharides (starches, maltodextrins, methylcelluloses, proteins, including but not limited to whey protein, peptides, gums), sugars (lactose, trehalose, sucrose), lipids (lecithin, vegetable oils, mineral oils), salts (sodium chloride, calcium carbonate, sodium citrate), silicates (clays, amorphous silica, fumed/precipitated silicas, silicate salts), waxes, oils, alcohol and surfactants.

The compositions of the present invention further comprising a formulation inert or other formulation ingredient, including but not limited to polysaccharides, including but not limited to starches, maltodextrins, and methylcelluloses; proteins, including but not limited to whey protein, peptides, and gums; sugars, including but not limited to lactose, trehalose, and sucrose; lipids including but not limited to lecithin, vegetable oils, and mineral oils; salts including but not limited to sodium chloride, calcium carbonate, and sodium citrate; and silicates including but not limited to clays, amorphous silica, fumed/precipitated silicas, and silicate salts. The compositions of the present invention may also comprise a carrier, including but not limited to water or a mineral or organic material. The composition may be used for seed treatment or as a root dip, the carrier is a binder or sticker that facilitates adherence of the composition to the seed or root. The compositions can be used as a seed treatment the formulation ingredient is a colorant. In other compositions, the formulation may further comprise a preservative.

Compositions of the present invention may further comprise formulation inerts added to compositions comprising cells, cell-free preparations or metabolites to improve efficacy, stability, and usability and/or to facilitate processing, packaging and end-use application. Such formulation inerts and ingredients may include carriers, stabilization agents, nutrients, or physical property modifying agents, which may be added individually or in combination. The carriers may include liquid materials including but not limited to water, oil, and other solvents and solid materials including but not limited to minerals, polymers, or polymer complexes derived biologically or by chemical synthesis. The carrier is a binder or adhesive that facilitates adherence of the composition to a plant part, including but not limited to a seed or root. See, for example, Taylor, et al., “Concepts and Technologies of Selected Seed Treatments,” Annu. Rev. Phytopathol., 28: 321-339 (1990). The stabilization agents include but are not limited to anti-caking agents, anti-oxidation agents, desiccants, protectants or preservatives. The nutrients may be carbon, nitrogen, and phosphors sources including but not limited to sugars, polysaccharides, oil, proteins, amino acids, fatty acids and phosphates. The physical property modifiers may be bulking agents, wetting agents, thickeners, pH modifiers, rheology modifiers, dispersants, adjuvants, surfactants, antifreeze agents, or colorants.

The composition as described herein may additionally comprising at least one auxiliary including but not limited to extenders, solvents, spontaneity promoters, carriers, emulsifiers, dispersants, frost protectants, thickeners and adjuvants. Those compositions may be referred to as formulations.

Examples of typical formulations include water-soluble liquids (SL), emulsifiable concentrates (EC), emulsions in water (EW), suspension concentrates (SC, SE, FS, OD), water-dispersible granules (WG), granules (GR) and capsule concentrates (CS); these and other possible types of formulation are described, for example, by CropLife International and in “Pesticide Specifications, Manual on Development and Use of FAO” and “WHO Specifications for Pesticides,” “FAO Plant Production and Protection Papers”—173, prepared by the FAO/WHO Joint Meeting on Pesticide Specifications, 2004, ISBN: 9251048576. The formulations may comprise active agrochemical compounds other than one or more active compounds of the invention.

The formulations or application forms may comprise auxiliaries, including but not limited to extenders, solvents, spontaneity promoters, carriers, emulsifiers, dispersants, frost protectants, biocides, thickeners and/or other auxiliaries, including but not limited to adjuvants, for example. An adjuvant in this context is a component which enhances the biological effect of the formulation, without the component itself having a biological effect. Examples of adjuvants are agents which promote the retention, spreading, attachment to the leaf surface, or penetration.

These formulations are produced in a known manner, for example by mixing the active compounds with auxiliaries including but not limited to, for example, extenders, solvents and/or solid carriers and/or further auxiliaries, including but not limited to surfactants. The formulations are prepared either in suitable plants or else before or during the application.

Suitable for use as auxiliaries are substances which are suitable for imparting to the formulation of the active compound or the application forms prepared from these formulations (including but not limited to, e.g., usable crop protection agents, including but not limited to spray liquors or seed dressings) particular properties including but not limited to certain physical, technical and/or biological properties.

Stabilizers, including but not limited to low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers including but not limited to carboxymethylcellulose, natural and synthetic polymers in powder, granule or latex form, including but not limited to gum arabic, polyvinyl alcohol, polyvinyl acetate, and also natural phospholipids, including but not limited to cephalins and lecithins, and synthetic phospholipids.

Further possible auxiliaries include mineral and vegetable oils. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, including but not limited to dioctyl sulphosuccinate, or increase the viscoelasticity, including but not limited to hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur, et al., 1997, Pesticide Science, 51, 131-152). Examples include alcohol alkoxylates including but not limited to coconut fatty ethoxylate (10) or isotridecyl ethoxylate (12), fatty acid esters including but not limited to rapeseed or soybean oil methyl esters, fatty amine alkoxylates including but not limited to tallowamine ethoxylate (15), or ammonium and/or phosphonium salts including but not limited to ammonium sulphate or diammonium hydrogen phosphate, for example.

This invention is further illustrated by the following additional examples that should not be construed as limiting. Those of skill in the art should, in light of the present disclosure, appreciate that many changes can be made to the specific embodiments which are disclosed and still obtain a like or similar result without departing from the spirit and scope of the invention.

### EXAMPLES

### Example 1. Antifungal Efficacy of Bacillus subtilis QST713 with Various Wetting Agents

The present study investigated the antifungal efficacy of a fermentation product containing Bacillus subtilis QST713 whole broth (WB) and one or more adjuvants. Various wetting agents were evaluated for their effect on the antifungal activity of the Bacillus subtilis QST713 fermentation product. Among the wetting agents tested was AGNIQUE® ANS 3DNP-U which contains sodium diisopropyl naphthalene sulfonate designated herein as “ANS”.

The fermentation product containing Bacillus subtilis QST713 WB was prepared by culturing the strain in a soy-based medium and mixing the resulting culture with ANS alone or with ANS and another adjuvant (designated herein as “Adjuvant 1”). ANS was added to reach a final concentration of 3% or 5% (w/w) and Adjuvant 1 was added to reach a final concentration of 3% (w/w) in the Bacillus subtilis QST713 WB. A positive control of an alternative formulation of Bacillus subtilis QST713 with increased antifungal activity (designated “QST713 Positive Control”) was included for purposes of comparison. In addition, ANS without any Bacillus subtilis QST713 WB was evaluated as a negative control.

Each of the treatments was applied to bell pepper plants at the rates indicated in Table 1. Subsequently, the plants were inoculated with a spore suspension of Botrytis cinerea. Several days later when disease was evident in the untreated control plants the plants were evaluated for percent disease control. The results shown in Table 1 are the average values of four independent measurements. A relatively high disease pressure affecting 100% of plants in the untreated control group was present. Percent disease control was scored with 0% indicating no difference in disease from the untreated control plants and 100% indicating no observable disease in the plants.

In previous studies, combinations of Adjuvant 1 with the Bacillus subtilis QST713 WB had shown greater antifungal activity than Bacillus subtilis QST713 WB or Adjuvant 1 alone. Surprisingly, WB+3% ANS outperformed both WB+3% Adjuvant 1 and WB+3% Adjuvant 1+3% ANS. Moreover, addition of a higher amount of ANS in the WB+5% ANS treatment further increased antifungal activity over that observed with the WB+3% ANS treatment. Importantly, treatment of infected plants with ANS alone resulted in no observable disease control.

Similar results were obtained in tomato plants.

TABLE 1
Average Disease Control Observed with Bacillus subtilis
QST713 WB Mixed with Adjuvant 1 alone,
Adjuvant 1 and ANS, or ANS Alone
Applied to Plants Infected with Botrytis cinerea

| | Application | % Disease |
|---|---|---|
| Sample Name | Rate | Control |
| WB + 3% Adjuvant 1 | 9% | 19 |
| WB + 3% Adjuvant 1 | 6% | 20 |
| WB + 3% Adjuvant 1 | 3% | 16 |
| WB + 3% Adjuvant 1 + 3% ANS | 9% | 90 |
| WB + 3% Adjuvant 1 + 3% ANS | 6% | 76 |
| WB + 3% Adjuvant 1 + 3% ANS | 3% | 60 |
| WB + 3% ANS | 9% | 93 |
| WB + 3% ANS | 6% | 99 |
| WB + 3% ANS | 3% | 88 |
| WB + 5% ANS | 9% | 97 |
| WB + 5% ANS | 6% | 99 |
| WB + 5% ANS | 3% | 98 |
| QST713 Positive Control | 2.5% | 99 |
| QST713 Positive Control | 1.25% | 77 |
| Untreated Control | — | 0 |

### Example 2. Comparison of Different Salts of Sodium Diisopropyl Naphthalene Sulfonate Combined with Bacillus subtilis QST713 in an Antifungal Assay

Sodium diisopropyl naphthalene sulfonate (“ANS”) can be obtained commercially from several vendors. The various ANS commercial products contain different salts of sodium diisopropyl naphthalene sulfonate. This experiment evaluated the antifungal activity of Bacillus subtilis QST713 fermentation product mixed with each of the following commercially available ANS products: AGNIQUE® ANS 3DNP-U (disodium sulfate salt of ANS), AEROSOL® OS (disodium sulfate salt of ANS), OPARYL™ MT704 (sulfate salt of ANS), MORWET® IP (sodium chloride salt of ANS), and SUPRAGIL® WP (sodium salt of ANS).

A Bacillus subtilis QST713 WB was prepared as described in Example 1 and concentrated via centrifugation and/or ultrafiltration by removal of part of the liquid portion to produce a broth concentrate (BC). The Bacillus subtilis QST713 BC was then mixed with each of the commercially available products at a final concentration of 5.5% (w/w) ANS. The antifungal assay described in Example 1 was performed with each of the treatments. The treatments were applied to plants at the lower rates shown in Table 2 given the concentrated nature of the Bacillus subtilis QST713 BC. A relatively high disease pressure affecting 100% of plants in the untreated control group was present.

Each of the commercially available products with ANS mixed with Bacillus subtilis QST713 BC demonstrated similar disease control in the plants infected with Botrytis cinerea (see Table 2). The differences in the salt composition of the commercial products did not significantly affect the antifungal activity of the combinations.

TABLE 2
Average Disease Control Observed with Bacillus subtilis
QST713 BC Mixed with Commercially Available ANS
Products Applied to Plants Infected with Botrytis cinerea

| | Application | % Disease |
|---|---|---|
| Sample Name | Rate | Control |
| BC + 5.5% AGNIQUE ® ANS 3DNP-U | 2.5% | 98 |
| BC + 5.5% AGNIQUE ® ANS 3DNP-U | 1.25% | 98 |
| BC + 5.5% AGNIQUE ® ANS 3DNP-U | 0.625% | 87 |
| BC + 5.5% AEROSOL ® OS | 2.5% | 97 |
| BC + 5.5% AEROSOL ® OS | 1.25% | 88 |
| BC + 5.5% AEROSOL ® OS | 0.625% | 59 |
| BC + 5.5% OPARYL ™ MT704 | 2.5% | 94 |
| BC + 5.5% OPARYL ™ MT704 | 1.25% | 95 |
| BC + 5.5% OPARYL ™ MT704 | 0.625% | 84 |
| BC + 5.5% MORWET ® IP | 2.5% | 97 |
| BC + 5.5% MORWET ® IP | 1.25% | 99 |
| BC + 5.5% MORWET ® IP | 0.625% | 73 |
| BC + 5.5% SUPRAGIL ® WP | 2.5% | 97 |
| BC + 5.5% SUPRAGIL ® WP | 1.25% | 99 |
| BC + 5.5% SUPRAGIL ® WP | 0.625% | 86 |
| QST713 Positive Control | 2.5% | 97 |
| QST713 Positive Control | 1.25% | 92 |
| QST713 Positive Control | 0.625% | 63 |
| Untreated Control | — | 0 |

### Example 3. Determination of Contact Angles on Leaf Surfaces from Droplets of Bacillus subtilis QST713 Whole Broth Mixed with Wetting Agents

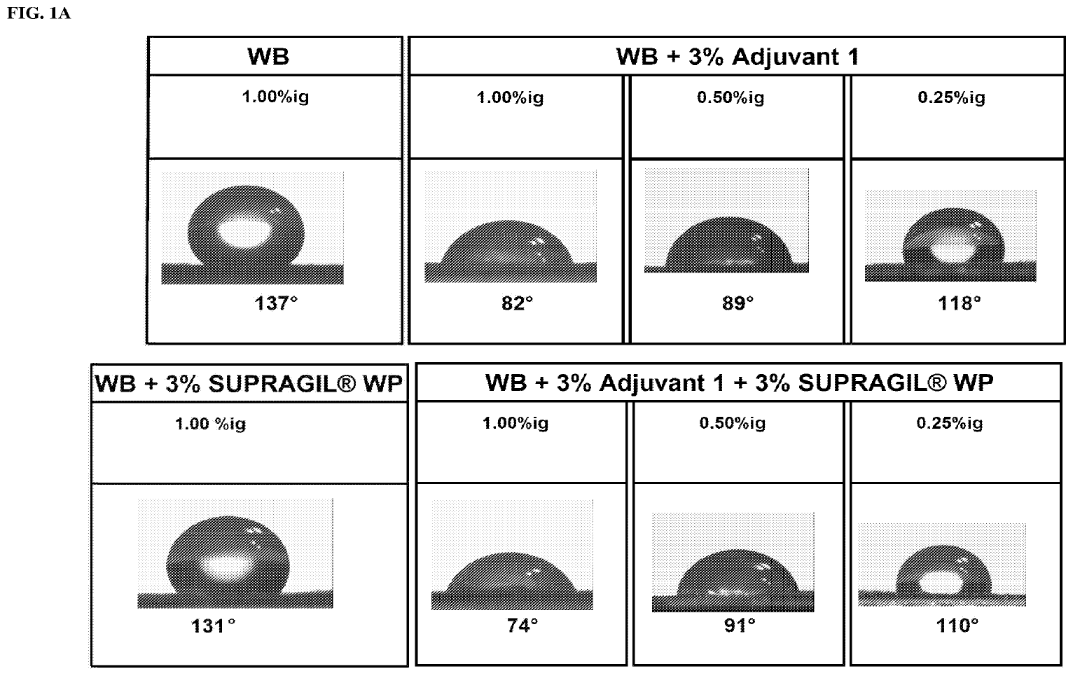

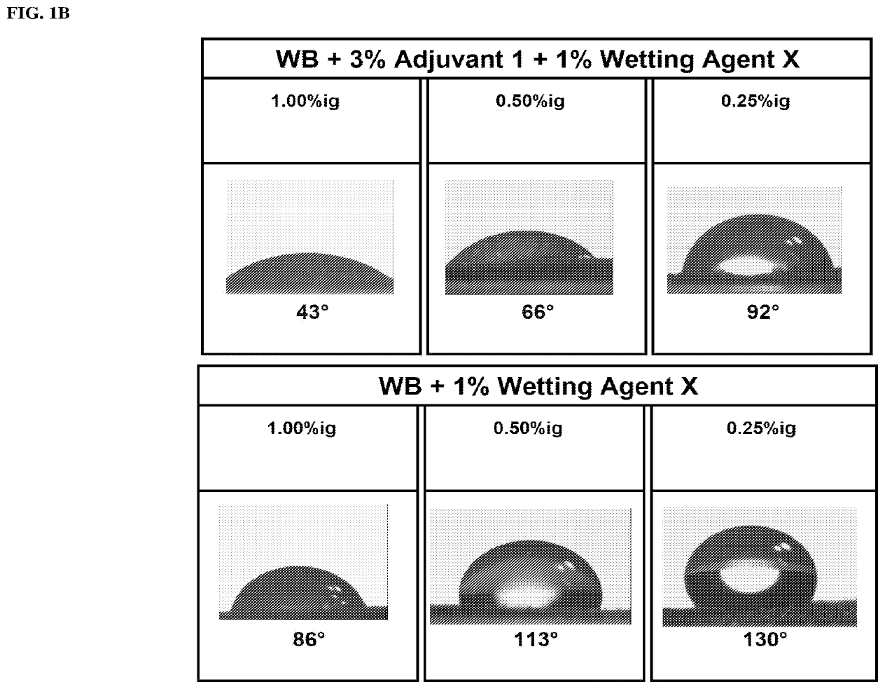

Bacillus subtilis QST713 WB was prepared as described in the previous examples and mixed with 3% (w/w) Adjuvant 1 alone or 3% (w/w) Adjuvant 1 with 3% (w/w) SUPRAGIL® WP (sodium salt of ANS) or 1% (w/w) of another wetting agent (designated “Wetting Agent X”). Control samples were prepared with Bacillus subtilis QST713 WB, Bacillus subtilis QST713 WB+3% (w/w) SUPRAGIL® WP (sodium salt of ANS), and Bacillus subtilis QST713 WB+1% (w/w) Wetting Agent X. Droplets of each of the samples were applied to a plant leaf surface, and the contact angles of the droplets were measured with the Krüss Goniometer Drop Shape Analyzer 10 (DSA10). The contact angles reported represent the averages measured over the last 90 seconds of a 2-minute analysis. Smaller contact angles formed at the interface of the droplet and the plant leaf surface indicate more effective wetting. To mimic the conditions under which the Bacillus subtilis QST713 fermentation product is applied to plants the formulations were diluted in water to 1.00%, 0.50%, or 0.25% (indicated as 1.00% ig, etc.) prior to application to the leaf surface. Photographs of the droplets along with the corresponding average contact angles are presented in FIGS. 1A and 1B.

Addition of Adjuvant 1 to the Bacillus subtilis QST713 WB decreased the contact angle of the droplets and improved wetting (see FIG. 1A). Addition of Wetting Agent X to the Bacillus subtilis QST713 WB+Adjuvant 1 further decreased the contact angle and resulting wetting of the leaf surface (see FIG. 1B). In contrast, addition of SUPRAGIL® WP (sodium salt of ANS) to the Bacillus subtilis QST713 WB had little effect on the contact angle (see FIG. 1A) suggesting that the increased antifungal activity observed with the combinations of Bacillus subtilis QST713 WB with ANS did not result from enhanced wetting of the plant leaf surfaces.

This experiment was repeated with Bacillus subtilis QST713 BC, Adjuvant 1, Wetting Agent X, and SUPRAGIL® WP (sodium salt of ANS). As with Bacillus subtilis QST713 WB, addition of Adjuvant 1 or Wetting Agent X to the Bacillus subtilis QST713 BC decreased the average contact angle of the droplets on the leaf surface whereas addition of SUPRAGIL® WP (sodium salt of ANS) had little effect on the average contact angle of the droplets (data not shown).

### Example 4. Solubilization of Lipopeptides Produced by Bacillus subtilis QST713 with Sodium Diisopropyl Naphthalene Sulfonate

Bacillus subtilis QST713 WB and Bacillus subtilis QST713 BC were prepared as described in the previous examples. Combinations of Bacillus subtilis QST713 WB with 3% (w/w) Adjuvant 1, 3% (w/w) ANS, or 5% (w/w) ANS were prepared. Combinations of Bacillus subtilis QST713 BC with 3% (w/w) ANS or 5% (w/w) ANS were also prepared. AGNIQUE® ANS 3DNP-U (disodium sulfate salt of ANS) was used for these experiments. To determine relative amounts of lipopeptides in the combinations samples were centrifuged to obtain the supernatant layer relatively free of spores. It was then filtered and separated on an analytical HPLC column and detected with a mass spectrometer (i.e., via LC-MS).

Peaks containing lipopeptides were identified by analysis of mass to charge (m/z) ratios. For example, “Iturin_1043_B” corresponds with an iturin peak in which the predominant m/z ratio detected by the mass spectrometer was 1043 corresponding with the molecular formula of C₄₈H₇₄N₁₂O₁₄. Relative quantification was performed by comparing the peak areas in the samples to those in an extract of a Bacillus subtilis QST713 WB used across different experiments as a reference standard.

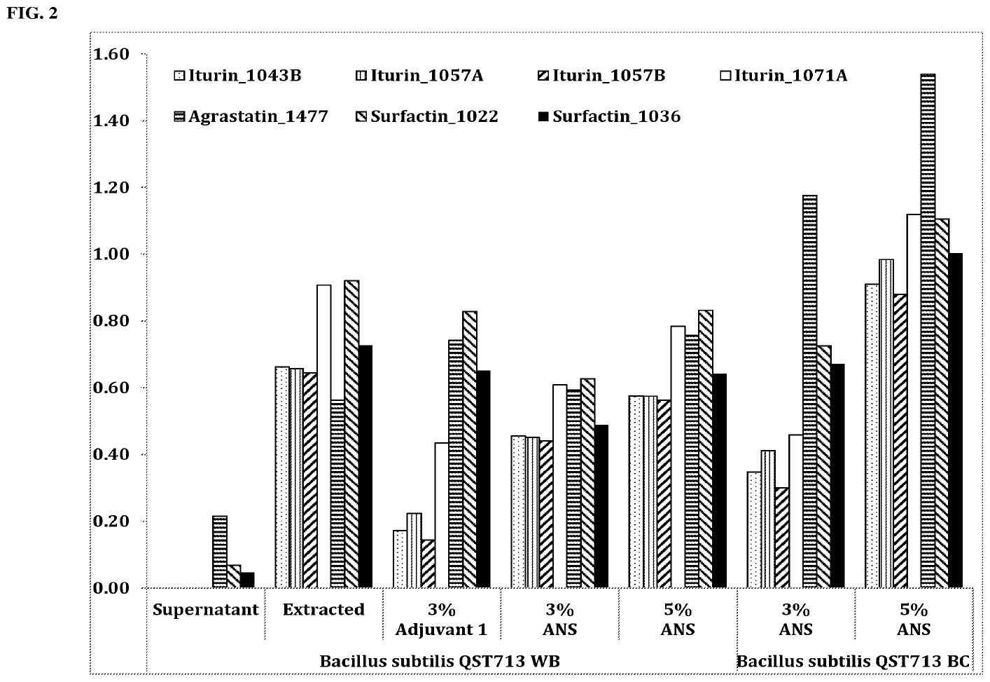

For purposes of comparison, an aliquot of the Bacillus subtilis QST713 WB that was present in the ANS combinations was also analyzed for relative lipopeptides levels. The Bacillus subtilis QST713 WB (the “Extracted” sample in FIG. 2) and a supernatant of the Bacillus subtilis QST713 WB removed after centrifugation (the “Supernatant” sample in FIG. 2) were analyzed via LC-MS. The “Extracted” and “Supernatant” samples were diluted with water and/or organic solvent so that similar amounts of WB samples were injected onto the HPLC. Relatively few lipopeptides were detected in the supernatant compared to the complete Bacillus subtilis QST713 WB (compare “Supernatant” and “Extracted” in FIG. 2).

Only the supernatants were analyzed in the combinations of Bacillus subtilis QST713 WB or BC with Adjuvant 1 or ANS. Addition of Adjuvant 1 to the Bacillus subtilis QST713 WB increased the amount of lipopeptides in the supernatant (compare “Supernatant” and “3% Adjuvant 1” in FIG. 2). When ANS was mixed with the Bacillus subtilis QST713 WB a similar increase in lipopeptides was detected in the supernatant, but there was an unexpected increase in the relative amounts of iturins in the supernatant that were about two to three times greater than those observed in the combination with Adjuvant 1 (compare “3% Adjuvant 1” and “3% ANS” in FIG. 2). With an increase from 3% to 5% of ANS came a corresponding increase of lipopeptides in the supernatants of both Bacillus subtilis QST713 WB and BC. Without wishing to be bound to any theory, these data suggest that the increased antifungal activity observed with the combinations of ANS and Bacillus subtilis QST713 result from increased solubility and bioavailability of the lipopeptides and, particularly, the iturins.

To confirm that the other commercially available forms of ANS behaved in a similar manner to AGNIQUE® ANS 3DNP-U (disodium sulfate salt of ANS) combinations of Bacillus subtilis QST713 BC and AEROSOL® OS (disodium sulfate salt of ANS), OPARYL™ MT704 (sulfate salt of ANS), MORWET® IP (sodium chloride salt of ANS), or SUPRAGIL® WP were prepared. Supernatants from each combination were separated and analyzed with LC-MS. Each of the commercial forms of ANS yielded similar results indicating that the differences in salt composition did not significantly affect the capacity of the various forms of ANS to solubilize the lipopeptides from the Bacillus subtilis QST713 BC (data not shown).

### Example 5. Effect of Increasing Amounts of Sodium Diisopropyl Naphthalene Sulfonate on Lipopeptide Solubilization in Bacillus subtilis QST713 Broth Concentrate

In the experiment described in Example 4, it was observed that increasing concentrations of ANS produced greater levels of lipopeptides in the supernatants of both Bacillus subtilis QST713 WB and BC. To further explore the effect of increasing the amount of ANS on lipopeptide solubility and bioavailability a Bacillus subtilis QST713 BC was prepared as described above, and increasing amounts of AGNIQUE® ANS 3DNP-U (disodium sulfate salt of ANS) were added to aliquots of the BC ranging from 3% (w/w) to 7.5% (w/w) with incremental increases of 0.5%. The combinations were then processed and analyzed with LC-MS as described in Example 4.

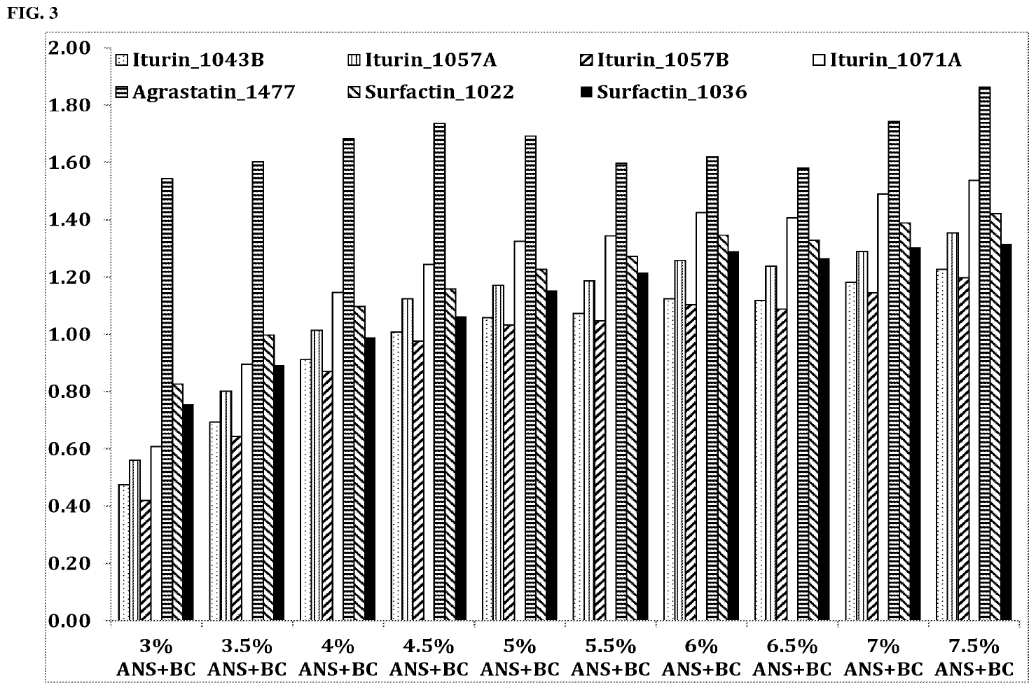

Marked increases in the lipopeptides levels were observed in the supernatants of the combinations as the concentration of AGNIQUE® ANS 3DNP-U (disodium sulfate salt of ANS) went from 3% (w/w) to 5% (w/w) (see FIG. 3). These increases became less pronounced between 5% and 7.5% AGNIQUE® ANS 3DNP-U (disodium sulfate salt of ANS) in the combinations. The combination of Bacillus subtilis QST713 BC with 7.5% AGNIQUE® ANS 3DNP-U (disodium sulfate salt of ANS) had the highest numerical levels of lipopeptides compared to the other combinations.

### Example 6. Antifungal Efficacy of Bacillus subtilis QST713 with Increasing Amounts of Sodium Diisopropyl Naphthalene Sulfonate

The antifungal activity of the samples prepared in Example 5 was assayed in young bell pepper plants that were inoculated with a spore suspension of Botrytis cinerea after treatment with each sample. The disease pressure in the untreated control plants was 96%. Four replicate measurements of percent disease control were taken for each sample treatment at the application rates shown in Table 3, and the averages are reported.

TABLE 3
Average Disease Control Observed with Bacillus subtilis
QST713 BC Mixed with Increasing Amounts of ANS

| | Application | % Disease |
|---|---|---|
| Sample Name | Rate | Control |
| BC + 3.0% AGNIQUE ® ANS 3DNP-U | 2.5% | 19 |
| BC + 3.0% AGNIQUE ® ANS 3DNP-U | 1.25% | 0 |
| BC + 3.0% AGNIQUE ® ANS 3DNP-U | 0.625% | 0 |
| BC + 3.5% AGNIQUE ® ANS 3DNP-U | 2.5% | 5 |
| BC + 3.5% AGNIQUE ® ANS 3DNP-U | 1.25% | 0 |
| BC + 3.5% AGNIQUE ® ANS 3DNP-U | 0.625% | 0 |
| BC + 4.0% AGNIQUE ® ANS 3DNP-U | 2.5% | 31 |
| BC + 4.0% AGNIQUE ® ANS 3DNP-U | 1.25% | 0 |
| BC + 4.0% AGNIQUE ® ANS 3DNP-U | 0.625% | 0 |
| BC + 4.5% AGNIQUE ® ANS 3DNP-U | 2.5% | 83 |
| BC + 4.5% AGNIQUE ® ANS 3DNP-U | 1.25% | 22 |
| BC + 4.5% AGNIQUE ® ANS 3DNP-U | 0.625% | 13 |
| BC + 5.0% AGNIQUE ® ANS 3DNP-U | 2.5% | 99 |
| BC + 5.0% AGNIQUE ® ANS 3DNP-U | 1.25% | 97 |
| BC + 5.0% AGNIQUE ® ANS 3DNP-U | 0.625% | 36 |
| BC + 5.5% AGNIQUE ® ANS 3DNP-U | 2.5% | 99 |
| BC + 5.5% AGNIQUE ® ANS 3DNP-U | 1.25% | 89 |
| BC + 5.5% AGNIQUE ® ANS 3DNP-U | 0.625% | 66 |
| BC + 6.0% AGNIQUE ® ANS 3DNP-U | 2.5% | 97 |
| BC + 6.0% AGNIQUE ® ANS 3DNP-U | 1.25% | 90 |
| BC + 6.0% AGNIQUE ® ANS 3DNP-U | 0.625% | 35 |
| BC + 6.5% AGNIQUE ® ANS 3DNP-U | 2.5% | 96 |
| BC + 6.5% AGNIQUE ® ANS 3DNP-U | 1.25% | 96 |
| BC + 6.5% AGNIQUE ® ANS 3DNP-U | 0.625% | 36 |
| BC + 7.0% AGNIQUE ® ANS 3DNP-U | 2.5% | 97 |
| BC + 7.0% AGNIQUE ® ANS 3DNP-U | 1.25% | 97 |
| BC + 7.0% AGNIQUE ® ANS 3DNP-U | 0.625% | 31 |
| BC + 7.5% AGNIQUE ® ANS 3DNP-U | 2.5% | 98 |
| BC + 7.5% AGNIQUE ® ANS 3DNP-U | 1.25% | 92 |
| BC + 7.5% AGNIQUE ® ANS 3DNP-U | 0.625% | 39 |
| QST713 Positive Control | 2.5% | 98 |
| QST713 Positive Control | 1.25% | 77 |
| QST713 Positive Control | 0.625% | 34 |
| Untreated Control | — | 0 |

The antifungal activities of the samples correlated with the levels of lipopeptides detected in the supernatants of the samples (see FIG. 3). Antifungal activity increased as the ANS went from 3% to 5% in the combinations with Bacillus subtilis QST713 BC and then remained relatively high in the Bacillus subtilis QST713 BC combinations with between 5% and 7.5% ANS (see Table 3). These results suggest that the solubilizing effect of the ANS on the lipopeptides is primarily responsible for the increased antifungal activity in the combinations with Bacillus subtilis QST713.

### Example 7. Synergistic Antifungal Effect of Combination of Sodium Diisopropyl Naphthalene Sulfonate and Bacillus subtilis QST713

A synergistic effect of fungicides is always present when the fungicidal activity of the active compound combinations exceeds the total of the activities of the active compounds when applied individually. The expected activity for a given combination of two active compounds can be calculated as follows (cf. Colby, S. R., “Calculating Synergistic and Antagonistic Responses of Herbicide Combinations,” Weeds, 1967, 15, 20-22):

If

X is the efficacy when active compound A is applied at an application rate of m ppm (or g/ha),

Y is the efficacy when active compound B is applied at an application rate of n ppm (or g/ha),

E is the efficacy when the active compounds A and B are applied at application rates of m and n ppm (or g/ha), respectively,

then

$$E = X + Y - \frac{X \cdot Y}{100}$$

The degree of efficacy, expressed in % is denoted. 0% means an efficacy which corresponds to that of the control while an efficacy of 100% means that no disease is observed.

If the actual fungicidal activity exceeds the calculated value, then the activity of the combination is super additive, i.e., a synergistic effect exists. In this case, the efficacy which was actually observed must be greater than the value for the expected efficacy (E) calculated from the above-mentioned formula.

Bacillus subtilis QST713 WB and BC were prepared as described in the previous examples. The WB and BC were applied to young plants alone or in combination with 7% (w/w) AGNIQUE® ANS 3DNP-U (disodium sulfate salt of ANS) at the application rates shown in Table 4. A control treatment of 7.5% AGNIQUE® ANS 3DNP-U (disodium sulfate salt of ANS) in water was also applied to the plants at the rates indicated in Table 4. Subsequently, the plants were inoculated with a spore suspension of Botrytis cinerea and scored for percent disease control when disease was evident in 100% of the untreated control plants. The results of the assay are presented in Table 4 with each disease control value representing the average of four replicates.

TABLE 4
Average Disease Control in Plants Infected with Botrytis cinerea

| | Application | % Disease Control | |
|---|---|---|---|
| Sample Name | Rate | Found* | Calc.** |
| Bacillus subtilis QST713 WB | 6% | 8 | |
| | 3% | 0 | |
| | 1.5% | 0 | |
| Bacillus subtilis QST713 BC | 6% | 1 | |
| | 3% | 10 | |
| | 1.5% | 0 | |
| 7.5% AGNIQUE ® ANS 3DNP-U | 6% | 0 | |
| | 3% | 0 | |
| | 1.5% | 0 | |
| Bacillus subtilis QST713 WB + | 6% | 78 | 8 |
| 7% AGNIQUE ® ANS 3DNP-U | 3% | 88 | 0 |
| | 1.5% | 78 | 0 |
| Bacillus subtilis QST713 BC + | 6% | 89 | 1 |
| 7% AGNIQUE ® ANS 3DNP-U | 3% | 90 | 10 |
| | 1.5% | 99 | 0 |
| QST713 Positive Control | 5% | 99 | |
| | 2.5% | 97 | |
| | 1.25% | 78 | |
| Untreated Control | — | 0 | |

*found = activity found
**calc. = activity calculated using Colby's formula

Application of the Bacillus subtilis QST713 WB or BC to the plants resulted in relatively weak disease control, and the AGNIQUE® ANS 3DNP-U (disodium sulfate salt of ANS) had no observable effect on the Botrytis cinerea infection of the plants. However, the combination of AGNIQUE® ANS 3DNP-U (disodium sulfate salt of ANS) with Bacillus subtilis QST713 WB or BC produced a markedly synergistic effect on disease control.

### Example 8. Antifungal Activity of Bacillus subtilis QST713 Combinations with Sodium Diisopropyl Naphthalene Sulfonate Added In-Can Versus as a Tank-Mix

Disease control agents are generally produced in a concentrated form and diluted prior to application to plants. The objective of this experiment was to determine the effect of addition of 5% (w/w) ANS to Bacillus subtilis QST713 WB in its concentrated form (i.e., as “5% In-Can”) or to the Bacillus subtilis QST713 WB after dilution in an equivalent amount (i.e., as “5% Equivalent in Tank-mix”).

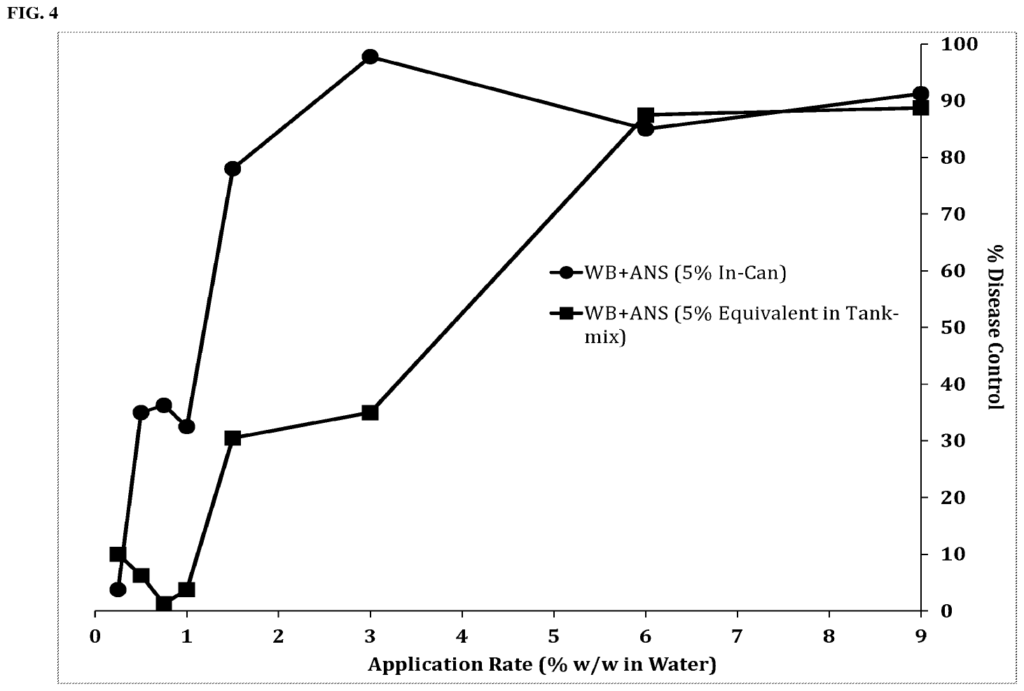

Bacillus subtilis QST713 WB was prepared as described in the previous examples. The undiluted WB was then mixed with 5% (w/w) AGNIQUE® ANS 3DNP-U (disodium sulfate salt of ANS) and subsequently diluted in water to 9%, 6%, 3%, 1.5%, 1%, 0.75%, 0.5%, and 0.25% (w/w) prior to application to plants. This first group of treatments was designated the “5% In-Can” group. In another group designated the “5% Equivalent in Tank-mix” group, the Bacillus subtilis QST713 WB was first diluted in water to the same final application rates and AGNIQUE® ANS 3DNP-U (disodium sulfate salt of ANS) was added to the diluted samples in an amount equivalent to the first group. Both groups of samples were applied to young plants that were later inoculated with Botrytis cinerea. The disease pressure in the untreated control plants was 100%. Four replicate measurements of disease control were evaluated for each treatment, and the average values are presented in the plot shown in FIG. 4.

The “5% In-Can” group demonstrated superior antifungal activity compared to the “5% Equivalent in Tank-mix” group at application rates as low as 0.5% and continuing until the 3% application rate (see FIG. 4). These results indicate that addition of the ANS to the undiluted Bacillus subtilis QST713 WB as would occur in an “in-can” formulation results in significantly greater antifungal activity than does addition of the ANS to diluted Bacillus subtilis QST713 WB as would occur in a “tank mix”.

### Example 9. Antifungal Activity of Bacillus subtilis QST713 Combinations with Other Alkyl Naphthalene Sulfonate Compounds

Other compounds with structural similarities to sodium diisopropylnaphthalene sulfonate (“ANS”) were evaluated for their ability to increase the solubility of the lipopeptides produced by Bacillus subtilis QST713. Among these compounds were the alkyl naphthalene sulfonate compounds AGNIQUE® ANS 4DNL (naphtahlenesulfonic acid dibutyl sodium salt with sodium sulfate) and AGNIQUE® ANS 3DNPW (naphtahlene sulfonic acid butyl sodium salt, naphtahlenesulfonic acid dibutyl sodium salt, and sodium sulfate). These compounds are similar to AGNIQUE® ANS 3DNP-U (sodium diisopropyl naphthalene sulfonate with sodium sulfate), but they have one or two n-butyl groups rather than isopropyl groups.

Bacillus subtilis QST713 BC was prepared as described in the previous examples, and aliquots were mixed with:
1) 5.5% (w/w) AGNIQUE® ANS 4DNL (naphtahlenesulfonic acid dibutyl sodium salt with sodium sulfate);
2) 5.5% (w/w) AGNIQUE® ANS 3DNPW (naphtahlene sulfonic acid butyl sodium salt, naphtahlenesulfonic acid dibutyl sodium salt, and sodium sulfate); or
3) 5.5% (w/w) AGNIQUE® ANS 3DNP-U (sodium diisopropyl naphthalene sulfonate with sodium sulfate).
   Supernatants from each of the combinations were separated and analyzed with LC-MS as described in Example 4. An aliquot of the Bacillus subtilis QST713 BC was also extracted and analyzed to measure the relative quantities of the lipopeptides in the BC before centrifugation and removal of the supernatant.

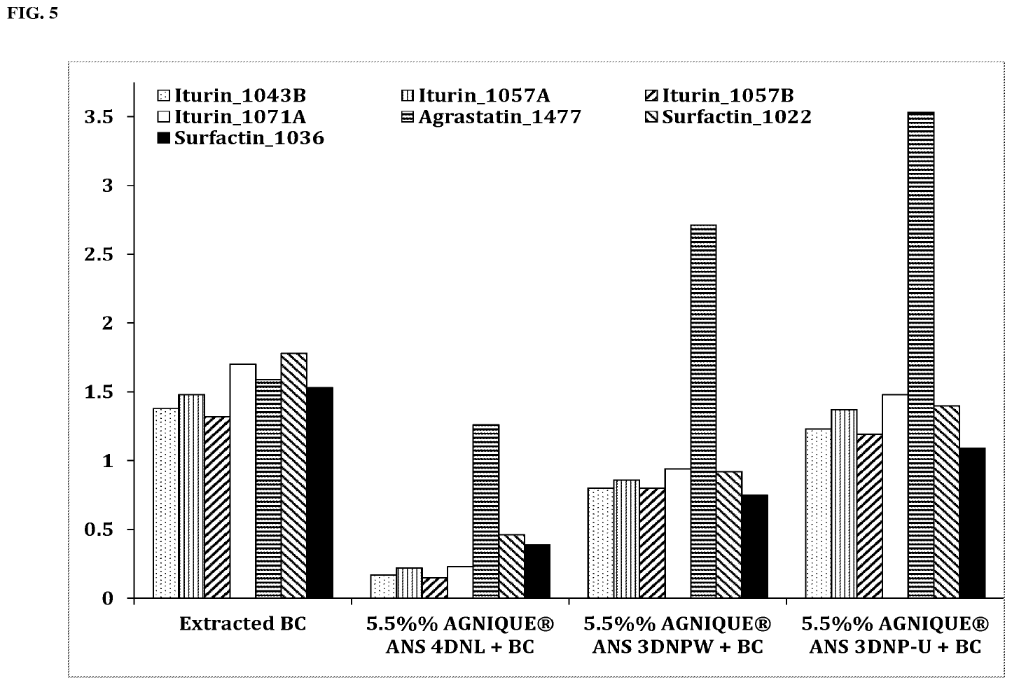

All three of the tested alkyl naphthalene sulfonate compounds demonstrated the capacity to solubilize the lipopeptides in Bacillus subtilis QST713 BC with AGNIQUE® ANS 3DNP-U and AGNIQUE® ANS 3DNPW providing the greatest increase in lipopeptide solubilization (see FIG. 5).

Each of the combinations was also evaluated for antifungal activity using the Botrytis cinerea assay described in the previous examples. As shown in Table 5, the AGNIQUE® ANS 3DNP-U and AGNIQUE® ANS 3DNPW combinations provided the strongest antifungal activity.

TABLE 5
Average Disease Control Observed with Bacillus subtilis QST713
BC Mixed with Alkyl Naphthalene Sulfonate Compounds

| | Application | % Disease |
|---|---|---|
| Sample Name | Rate | Control |
| BC + 5.5% AGNIQUE ® ANS 3DNP-U | 2.5% | 65 |
| BC + 5.5% AGNIQUE ® ANS 3DNP-U | 1.25% | 69 |
| BC + 5.5% AGNIQUE ® ANS 3DNP-U | 0.625% | 10 |
| BC + 5.5% AGNIQUE ® ANS 3DNPW | 2.5% | 78 |
| BC + 5.5% AGNIQUE ® ANS 3DNPW | 1.25% | 24 |
| BC + 5.5% AGNIQUE ® ANS 3DNPW | 0.625% | 11 |
| BC + 5.5% AGNIQUE ® ANS 4DNL | 2.5% | 8 |
| BC + 5.5% AGNIQUE ® ANS 4DNL | 1.25% | 0 |
| BC + 5.5% AGNIQUE ® ANS 4DNL | 0.625% | 0 |
| QST713 Positive Control | 2.5% | 94 |
| QST713 Positive Control | 1.25% | 66 |
| QST713 Positive Control | 0.625% | 0 |
| Untreated Control | — | 0 |

### Example 10. Residual Antifungal Activity of Bacillus subtilis QST713 Combination with Sodium Diisopropyl Naphthalene Sulfonate

A whole tomato fruit assay was used to evaluate residual antifungal activity of the Bacillus subtilis QST713 combinations with ANS. Bacillus subtilis QST713 WB and BC were prepared as described in the previous examples and mixed with 3%, 5%, or 7.5% (w/w) AGNIQUE® ANS 3DNP-U (disodium sulfate salt of ANS). Whole tomatoes were dipped in the combinations and a spore suspension of Botrytis cinerea was applied to the tomatoes one, four, or seven days after treatment. Several days after inoculation with Botrytis cinerea the tomatoes were scored for percent disease control with 0% indicating no difference from the untreated control and 100% indicating no observable disease. All residual antifungal activity values reported represent the averages of three replicates.

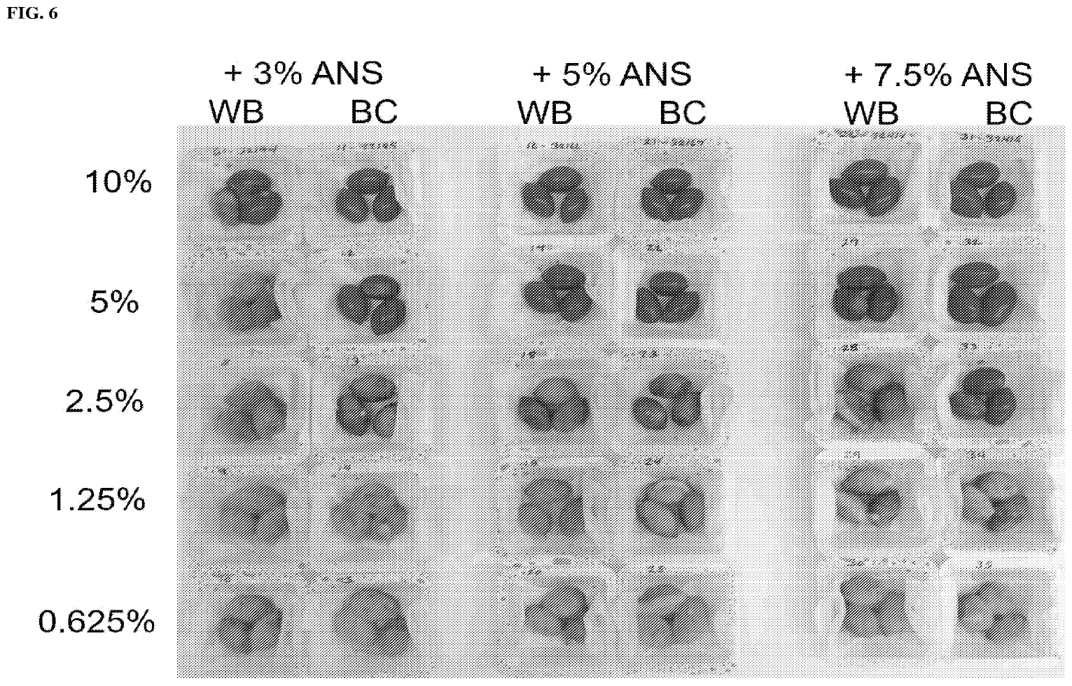

In an initial experiment evaluating the one-day residual activity of the combinations, the ANS combinations with BC provided greater disease control than did the corresponding combinations with WB, and disease control improved with higher amounts of ANS in the BC or WB combinations (see FIG. 6 and Table 6). In subsequent experiments, the residual antifungal activity of the combinations was shown to extend as long as seven days after treatment of the tomatoes (see Table 7).

TABLE 6
1-Day Residual Antifungal Activity Observed with
Bacillus subtilis QST713 WB and
BC Mixed with 3%, 5%, or 7.5% (w/w) ANS

| | Application | % Disease |
|---|---|---|
| Sample Name | Rate | Control |
| WB + 3% AGNIQUE ® ANS 3DNP-U | 10% | 78 |
| WB + 3% AGNIQUE ® ANS 3DNP-U | 5% | 0 |
| WB + 3% AGNIQUE ® ANS 3DNP-U | 2.5% | 0 |
| WB + 3% AGNIQUE ® ANS 3DNP-U | 1.25% | 0 |
| WB + 3% AGNIQUE ® ANS 3DNP-U | 0.625% | 0 |
| BC + 3% AGNIQUE ® ANS 3DNP-U | 10% | 100 |
| BC + 3% AGNIQUE ® ANS 3DNP-U | 5% | 88 |
| BC + 3% AGNIQUE ® ANS 3DNP-U | 2.5% | 20 |
| BC + 3% AGNIQUE ® ANS 3DNP-U | 1.25% | 0 |
| BC + 3% AGNIQUE ® ANS 3DNP-U | 0.625% | 0 |
| WB + 5% AGNIQUE ® ANS 3DNP-U | 10% | 100 |
| WB + 5% AGNIQUE ® ANS 3DNP-U | 5% | 100 |
| WB + 5% AGNIQUE ® ANS 3DNP-U | 2.5% | 20 |
| WB + 5% AGNIQUE ® ANS 3DNP-U | 1.25% | 3 |
| WB + 5% AGNIQUE ® ANS 3DNP-U | 0.625% | 0 |
| BC + 5% AGNIQUE ® ANS 3DNP-U | 10% | 100 |
| BC + 5% AGNIQUE ® ANS 3DNP-U | 5% | 98 |
| BC + 5% AGNIQUE ® ANS 3DNP-U | 2.5% | 57 |
| BC + 5% AGNIQUE ® ANS 3DNP-U | 1.25% | 3 |
| BC + 5% AGNIQUE ® ANS 3DNP-U | 0.625% | 0 |
| WB + 7.5% AGNIQUE ® ANS 3DNP-U | 10% | 99 |
| WB + 7.5% AGNIQUE ® ANS 3DNP-U | 5% | 93 |
| WB + 7.5% AGNIQUE ® ANS 3DNP-U | 2.5% | 17 |
| WB + 7.5% AGNIQUE ® ANS 3DNP-U | 1.25% | 7 |
| WB + 7.5% AGNIQUE ® ANS 3DNP-U | 0.625% | 0 |
| BC + 7.5% AGNIQUE ® ANS 3DNP-U | 10% | 100 |
| BC + 7.5% AGNIQUE ® ANS 3DNP-U | 5% | 100 |
| BC + 7.5% AGNIQUE ® ANS 3DNP-U | 2.5% | 87 |
| BC + 7.5% AGNIQUE ® ANS 3DNP-U | 1.25% | 7 |
| BC + 7.5% AGNIQUE ® ANS 3DNP-U | 0.625% | 0 |
| QST713 Positive Control | 10% | 82 |
| QST713 Positive Control | 5% | 90 |
| QST713 Positive Control | 2.5% | 70 |
| QST713 Positive Control | 1.25% | 53 |
| QST713 Positive Control | 0.625% | 0 |
| Untreated Control | — | 0 |

TABLE 7
1-Day, 4-Day, and 7-Day Residual Antifungal Activity Observed
with Bacillus subtilis QST713 BC Mixed with 7.5% (w/w) ANS

| | | |
|---|---|---|
| | Application | % Disease |
| Sample Name | Rate | Control |

1-DAY RESIDUAL ANTIFUNGAL ACTIVITY ASSESSMENTS

| | | |
|---|---|---|
| BC + 7.5% AGNIQUE ® ANS 3DNP-U | 10% | 98 |
| BC + 7.5% AGNIQUE ® ANS 3DNP-U | 5% | 97 |
| BC + 7.5% AGNIQUE ® ANS 3DNP-U | 2.5% | 90 |
| BC + 7.5% AGNIQUE ® ANS 3DNP-U | 1.25% | 67 |
| BC + 7.5% AGNIQUE ® ANS 3DNP-U | 0.625% | 17 |
| QST713 Positive Control | 10% | 67 |
| QST713 Positive Control | 5% | 23 |
| QST713 Positive Control | 2.5% | 17 |
| QST713 Positive Control | 1.25% | 0 |
| QST713 Positive Control | 0.625% | 17 |
| 7.5% AGNIQUE ® ANS 3DNP-U in Water | 10% | 17 |
| 7.5% AGNIQUE ® ANS 3DNP-U in Water | 5% | 13 |
| 7.5% AGNIQUE ® ANS 3DNP-U in Water | 2.5% | 0 |
| 7.5% AGNIQUE ® ANS 3DNP-U in Water | 1.25% | 0 |
| 7.5% AGNIQUE ® ANS 3DNP-U in Water | 0.625% | 0 |

4-DAY RESIDUAL ANTIFUNGAL ACTIVITY ASSESSMENTS

| | | |
|---|---|---|
| BC + 7.5% AGNIQUE ® ANS 3DNP-U | 10% | 93 |
| BC + 7.5% AGNIQUE ® ANS 3DNP-U | 5% | 97 |
| BC + 7.5% AGNIQUE ® ANS 3DNP-U | 2.5% | 70 |
| BC + 7.5% AGNIQUE ® ANS 3DNP-U | 1.25% | 43 |
| BC + 7.5% AGNIQUE ® ANS 3DNP-U | 0.625% | 13 |
| QST713 Positive Control | 10% | 17 |
| QST713 Positive Control | 5% | 13 |
| QST713 Positive Control | 2.5% | 0 |
| QST713 Positive Control | 1.25% | 0 |
| QST713 Positive Control | 0.625% | 0 |
| 7.5% AGNIQUE ® ANS 3DNP-U in Water | 10% | 0 |
| 7.5% AGNIQUE ® ANS 3DNP-U in Water | 5% | 0 |
| 7.5% AGNIQUE ® ANS 3DNP-U in Water | 2.5% | 0 |
| 7.5% AGNIQUE ® ANS 3DNP-U in Water | 1.25% | 0 |
| 7.5% AGNIQUE ® ANS 3DNP-U in Water | 0.625% | 0 |

7-DAY RESIDUAL ANTIFUNGAL ACTIVITY ASSESSMENTS

| | | |
|---|---|---|
| BC + 7.5% AGNIQUE ® ANS 3DNP-U | 10% | 77 |
| BC + 7.5% AGNIQUE ® ANS 3DNP-U | 5% | 73 |
| BC + 7.5% AGNIQUE ® ANS 3DNP-U | 2.5% | 17 |
| BC + 7.5% AGNIQUE ® ANS 3DNP-U | 1.25% | 10 |
| BC + 7.5% AGNIQUE ® ANS 3DNP-U | 0.625% | 7 |
| QST713 Positive Control | 10% | 13 |
| QST713 Positive Control | 5% | 0 |
| QST713 Positive Control | 2.5% | 0 |
| QST713 Positive Control | 1.25% | 0 |
| QST713 Positive Control | 0.625% | 0 |
| 7.5% AGNIQUE ® ANS 3DNP-U in Water | 10% | 0 |
| 7.5% AGNIQUE ® ANS 3DNP-U in Water | 5% | 0 |
| 7.5% AGNIQUE ® ANS 3DNP-U in Water | 2.5% | 0 |
| 7.5% AGNIQUE ® ANS 3DNP-U in Water | 1.25% | 0 |
| 7.5% AGNIQUE ® ANS 3DNP-U in Water | 0.625% | 0 |
| Untreated Control | — | 0 |

### Example 11. Stabilization of Compositions/Formulations Comprising Microbial Lipoprotein and Sodium Diisopropyl Naphthalene Sulfonate

Sodium diisopropyl naphthalene (ANS) also was evaluated for its ability to stabilize lipopeptide-containing compositions and formulations and increase shelf-life of such compositions. Eight formulations were made and evaluated per Table 8, below. Specifically, formulations containing broth concentrate of Bacillus subtilis/amyloliquefaciens QST713 (“BC”) and sodium diisopropyl naphthalene, AGNIQUE® ANS 3DNP-U or Morwet IP (Formulations 2 and 3), were compared with formulations containing known preservatives potassium sorbate and sodium benzoate (Formulation 1, positive control), formulations with AGNIQUE® ANS 3DNP-U or Morwet IP and potassium sorbate or sodium benzoate (Formulations 4-7), and a formulation without any preservatives (Formulation 8). At 0, 12, 26, 52, 78, 104, and 130 weeks the formulations were evaluated for stability by measuring the concentration of colony forming units of QST713 in the broth concentrate. Also, at 0, 2, 12, 26, 52, 78, 104, and 130 weeks the formulations were evaluated for the ability of each formulation (with its particular preservatives or lack of preservatives) to control pathogens. Formulation samples for weeks 0, 26, 52, 78, 104 and 130 were stored at room temperature. Formulation samples for week 12 were held at 40° C.

To determine the ability of each formulation to prevent contamination, an aliquot of each formulation was inoculated with 1% viable microorganism mixture containing E. coli, P. aeruginosa, S. aureus, and C. albicans. The concentration of each pathogen microorganism (CFU/mL) was determined at the start of the assay and then the change in log₁₀ values for each microorganism was evaluated at 7, 14 and 28 days after inoculation. Changes are expressed in terms of log reductions. Final results are pass/fail, as shown in Table 9 below, as MC PASS or MC FAIL.

TABLE 8
Formulations Evaluated for Stability
FORMULATIONS FOR EVALUATION OF STABILITY

| Formualtion | Form. 1 | Form. 2 | Form. 3 | Form 4 |
|---|---|---|---|---|
| components | % w/w | % w/w | % w/w | % w/w |
| BC | 89.06 | 89.06 | 89.06 | 89.06 |
| K-sorbate | 0.53 | 0 | 0 | 0.53 |
| Na benzoate | 0.53 | 0 | 0 | 0 |
| AGNIQUE® ANS | 0 | 5.5 | 0 | 5.5 |
| 3DNP-U | | | | |
| MORWET IP | 0 | 0 | 5.5 | 0 |
| salt tolerant xanthum | 0.10 | 0.10 | 0.10 | 0.10 |
| gum, rheological | | | | |
| modifier | | | | |
| antifreeze and | 0.8 | 0.8 | 0.8 | 0.8 |
| humectant | | | | |
| Antifoam and | 0.06 | 0.06 | 0.06 | 0.06 |
| emulsifiers | | | | |
| DI water | 8.92 | 4.48 | 4.48 | 3.95 |
| Formulation | Form. 5 | Form. 6 | Form. 7 | Form. 8 |
| components | % w/w | % w/w | % w/w | % w/w |
| BC | 89.06 | 89.06 | 89.06 | 89.06 |
| K-sorbate | 0 | 0.53 | 0.53 | 0 |
| Na benzoate | 0.53 | 0.53 | 0.53 | 0 |
| AGNIQUE® ANS | 5.5 | 5.5 | 0 | 0 |
| 3DNP-U | | | | |
| MORWET IP | 0 | 0 | 5.5 | 0 |
| salt tolerant xanthum | 0.10 | 0.10 | 0.10 | 0 |
| gum, rheological | | | | |
| modifier | | | | |
| antifreeze and | 0.8 | 0.8 | 0.8 | 0 |
| humectant | | | | |
| Antifoam and | 0.06 | 0.06 | 0.06 | 0 |
| emulsifiers | | | | |
| DI water | 3.95 | 3.42 | 3.42 | 10.94 |

Each formulation was tested for microbial contamination (MC) at various timepoints. The results over time are presented in Table 9, below. The formulations were also evaluated for colony forming units (CFU/g) of QST713.

TABLE 9
Enhanced Stability of Formulations of Lipoproteins with ANS
STABILITY OVER TIME

| Time | Form. 1 | Form. 2 | Form. 3 | Form 4 |
|---|---|---|---|---|
| Time zero | 3.01 × 10⁹ | 7.84 × 10⁸ | 1.13 × 10⁹ | 8.35 × 10⁸ |
| | MC PASS | MC PASS | MC PASS | MC PASS |
| 2 weeks | — | — | — | — |
| | MC PASS | MC PASS | MC PASS | MC PASS |
| 12 weeks | 2.58 × 10⁹ | 6.45 × 10⁸ | 1.99 × 10⁹ | 9.27 × 10⁸ |
| | MC PASS | MC PASS | MC PASS | MC PASS |
| 26 weeks | 3.56 × 10⁹ | 1.03 × 10⁹ | 6.09 × 10⁸ | 1.84 × 10⁹ |
| | MC PASS | MC PASS | MC PASS | MC PASS |
| 52 weeks | 3.47 × 10⁹ | 2.32 × 10⁹ | 1.20 × 10⁹ | 2.56 × 10⁹ |
| | MC PASS | MC PASS | MC PASS | MC PASS |
| 78 weeks | 3.15 × 10⁹ | 1.75 × 10⁹ | 1.27 × 10⁹ | 2.72 × 10⁹ |
| | MC PASS | MC PASS | MC PASS | MC PASS |
| 104 weeks | 2.90 × 10⁹ | 1.71 × 10⁹ | 1.35 × 10⁹ | 1.99 × 10⁹ |
| | MC PASS | MC PASS | MC PASS | MC PASS |
| 130 weeks | 2.85 × 10⁹ | 1.61 × 10⁹ | 1.20 × 10⁹ | 1.87 × 10⁹ |
| | MC PASS | MC PASS | MC PASS | MC PASS |
| Time | Form. 5 | Form. 6 | Form. 7 | Form. 8 |
| Time zero | 9.93 × 10⁸ | 9.35 × 10⁸ | 1.04 × 10⁹ | 3.11 × 10⁹ |
| | MC PASS | MC PASS | MC PASS | MC PASS |
| 2 weeks | — | — | — | — |
| | MC PASS | MC PASS | MC PASS | MC FAIL |
| 12 weeks | 6.07 × 10⁸ | 6.40 × 10⁸ | 1.27 × 10⁹ | 3.73 × 10⁹ |
| | MC PASS | MC PASS | MC PASS | MC FAIL |
| 26 weeks | 1.58 × 10⁹ | 1.58 × 10⁹ | 1.66 × 10⁹ | 2.78 × 10⁹ |
| | MC PASS | MC PASS | MC PASS | MC FAIL |
| 52 weeks | 2.53 × 10⁹ | 2.77 × 10⁹ | — | — |
| | MC PASS | MC PASS | — | — |
| 78 weeks | 2.61 × 10⁹ | 2.96 × 10⁹ | — | — |
| | MC PASS | MC PASS | — | — |
| 104 weeks | 2.57 × 10⁹ | 2.77 × 10⁹ | — | — |
| | MC PASS | MC PASS | — | — |
| 130 weeks | 2.47 × 10⁹ | 2.38 × 10⁹ | — | — |
| | MC PASS | MC PASS | — | — |

Unless defined otherwise, all technical and scientific terms herein have the same meaning as commonly understood by one of ordinary skill in the art to which this invention belongs. All publications, patents, and patent publications cited are incorporated by reference herein in their entirety for all purposes.

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

Those skilled in the art will recognize, or be able to ascertain using no more than routine experimentation, many equivalents to the specific embodiments of the invention described herein. Such equivalents are intended to be encompassed by the following claims.

1. A composition comprising:
a) a lipopeptide-producing microorganism, wherein the lipopeptide is a surfactin-type lipopeptide, an iturin-type lipopeptide, or a fengycin-type lipopeptide, or a combination thereof, or a fermentation product or cell-free preparation of the lipopeptide-producing microorganism; and
b) a compound of formula (I): 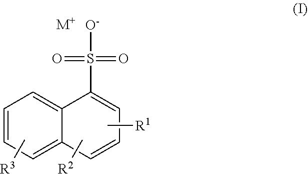
or a compound of formula (II): 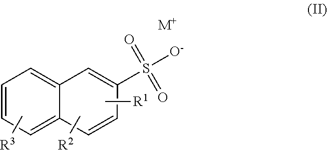
wherein
R¹, R², and R³ are independently H or a linear or branched C₁₋₂₀ alkyl with the proviso that R¹, R², and R³ are not all H; and
when it is present, M⁺ is selected from the group consisting of H⁺, Li⁺, Na⁺, K⁺, and NH₄⁺;
or an agriculturally acceptable salt, metal complex or metalloid complex of a compound of formula (I) or a compound of formula (II);
in a synergistically effective amount.

2. The composition of claim 1, wherein R¹, R², and R³ are independently H, isopropyl, or butyl.

3. The composition of claim 1, wherein component b) is diisopropylnaphthalenesulfonic acid or an agriculturally acceptable salt, metal complex or metalloid complex thereof.

4. The composition of claim 1, wherein component b) is 2,3-di(propan-2-yl)naphthalene-1-sulfonic acid; 3,6-di(propan-2-yl)naphthalene sulfonic acid; 4,7-di(propan-2-yl)naphthalene-2-sulfonic acid; or an agriculturally acceptable salt, metal complex or metalloid complex thereof.

5. The composition of claim 1, wherein the lipopeptide-producing microorganism is a Bacillus spp.

6. The composition according claim 5, wherein the Bacillus spp. is Bacillus subtilis or Bacillus amyloliquefaciens.

7. The composition of claim 1, wherein the lipopeptide-producing microorganism is Bacillus subtilis QST713, Bacillus amyloliquefaciens strain D747, Bacillus subtilis MBI600, Bacillus subtilis var. amyloliquefaciens FZB24, or a mutant thereof having all the identifying characteristics of the respective strain.

8-10. (canceled)

11. A method of controlling fungal harmful organisms in a plant, the method comprising applying an effective amount of the composition of claim 5 to the plant, to a part of the plant, to seed, and/or to a locus on which the plant or plant part grows or is to be planted.

12. The method of claim 11, wherein the fungal harmful organisms are Phytophthora infestans and/or Botrytis cinerea and/or Plasmopara viticola and/or Sphaerotheca fuliginea and/or Venturia inaequalis and/or Alternaria solani and/or Uromyces appendiculatus and/or Phakopsora pachyrhizi.

13. (canceled)

14. The method of claim 11, wherein the plant is selected from the group consisting of apples, bell peppers, strawberries, bananas, citrus, kiwi, melons, peaches, pears, pineapple, pome fruit, pomegranate, cabbage, cauliflower, cucumbers, cucurbits, tomatoes, potatoes, wheat, rice and soybeans.

15. The method according to claim 11, wherein the fungicidal composition is applied as a foliar treatment.

16-17. (canceled)

18. A method of preserving a composition comprising a surfactin-type lipopeptide, an iturin-type lipopeptide, or a fengycin-type lipopeptide, or a combination thereof, comprising adding a compound of formula (I): 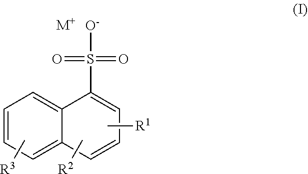
or a compound of formula (II): 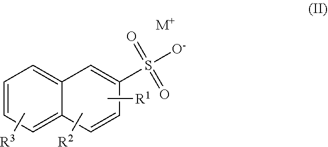
wherein
R¹, R², and R³ are independently H or a linear or branched C₁₋₂₀ alkyl with the proviso that R¹, R², and R³ are not all H; and
when it is present, M⁺ is selected from the group consisting of H⁺, Li⁺, Na⁺, K⁺, and NH₄⁺;
or an agriculturally acceptable salt, metal complex or metalloid complex of a compound of formula (I) or a compound of formula (II).
wherein R¹, R², and R³ are independently H, isopropyl, or butyl.

19. The method of claim 18, wherein component b) is diisopropylnaphthalenesulfonic acid or an agriculturally acceptable salt, metal complex or metalloid complex thereof.

20. The method of claim 18, wherein component b) is 2,3-di(propan-2-yl)naphthalene-1-sulfonic acid; 3,6-di(propan-2-yl)naphthalene sulfonic acid; 4,7-di(propan-2-yl)naphthalene-2-sulfonic acid; or an agriculturally acceptable salt, metal complex or metalloid complex thereof.

21. The method of claim 18, wherein the composition is preserved for 12 to 130 weeks.

22. The method of claim 18, wherein the composition comprises a surfactin-type lipopeptide, an iturin-type lipopeptide, and a fengycin-type lipopeptide.

23. The method of claim 22 wherein the composition is a fermentation product of a Bacillus spp. microorganism.

24. The method of claim 23, wherein the Bacillus spp. microorganism is Bacillus subtilis or Bacillus amyloliquefaciens.
